(19) United States
(12) Patent Application Publication
(10) Pub. No.: US 2005/0196737 A1
(43) Pub. Date: Sep. 8, 2005

(54) Systems and methods of measuring and evaluating performance of a physical skill and equipment used to perform the physical skill

(76) Inventor: Ralph V. Mann, Henderson, NV (US)

Correspondence Address: Mintz, Levin, Cohn, Ferris,;Glovsky and Popeo, P.C., One Financial Center, Boston, MA, 02111, US

(21) Appl. No.: 11/052,711

(22) Filed: Jan. 26, 2005

Related U.S. Application Data
(60) Provisional application No. 60/539,385, filed on Jan. 26, 2004.

(51) Int. Cl. G09B 19/00

(52) U.S. Cl. 434/247

(57) ABSTRACT

Systems and methods are provided for processing an individual performance data model of a person, such as a student, performing a physical skill or task. The individual performance data model is derived from an elite or superior performance data model determined from a number of elite or superior performances of the skill or task. In particular, the elite or superior performance model is sized or scaled to the student's body dimensions to produce a customized individual performance data model of the student's ideal or superior performance of the skill. The individual performance data model is used in teaching processes to identify and correct the student's performance errors. Embodiments of the invention modify the individual performance data model of the student to incorporate significant body movement trends exhibited by elite or superior performers that are related to body segment size. Further embodiments of the invention modify the individual performance data model for evaluating and scoring the student's actual performance of the skill, and for evaluating and fitting equipment the student uses to perform the skill. In particular, embodiments of the invention seek to alleviate the technical problem of how to process video data streams captured of the student's actual performance of the skill to automate the identification of errors in the student's performance, to automate the corrective action the student must take to improve his/her performance and/or to avoid such errors, and to automatically assess the suitability and performance of equipment the student uses to perform the skill.

### CLAIM OF PRIORITY TO PRIOR APPLICATION

This application claims priority under 35 U.S.C. § 119(e) to U.S. provisional patent application Ser. No. 60/539,385, filed on Jan. 26, 2004, which is by reference incorporated herein in its entirety.

### FIELD OF THE INVENTION

The invention relates to measuring and analyzing human movement in the performance of a physical skill and results of equipment used to perform the skill for purposes of evaluation, teaching and equipment fitting.

### BACKGROUND OF THE INVENTION

Current analyses of human movement or the performance of a physical skill, such as a sports skill or activity, rely substantially upon human opinion. For example, for every opinion of the best way to swing a golf club, another opinion exists that the swing should be performed in a different manner. One faction professes a golf swing should consist of a whole body shift away and then toward the target, while another faction professes the best way to swing is with a pure body turn. In addition, in many cases, the performance errors golfers demonstrate in their swings are precisely the movements that instructors and teachers have taught them with the goal of improving their swings. Further, performance evaluations in a teaching and learning environment are often qualitative where an instructor or teacher views a subject's golf swing and then provides an opinion concerning the quality of the swing and the performance errors demonstrated, as well as provides recommendations for equipment fittings. Such opinions may be based on video images that capture a student's swing and may further rely on equipment results data that can be measured using such known technologies as club and ball capture technology. However, much of the quantitative potential of this performance information is lost because it is typically compared with a model of an ideal or superior swing that resides in the mind of the instructor or teacher.

For proper measurement and evaluation of human movement, four areas in particular of human motion must be quantified in order to provide a reliable performance evaluation tool that consistently determines flaws in performance. Such areas include: (1) recording and measuring a subject's performance of a physical skill or activity; (2) determining a performance model of a superior performance of the physical skill to serve as a standard to which the subject's performance can be compared; (3) recording and measuring performance of equipment used in the skill; and (4) determining a performance model of equipment used in the performance to serve as a standard to which the student's equipment can be compared.

Some of these areas have been addressed in the applicant's prior patents, including U.S. Pat. No. 4,891,748 and U.S. Pat. No. 5,184,295, which teach processes for generating a standardized elite or superior performance model that serves as a standard model. The teachings of the prior patents are presented with respect to a golf swing and the standardized elite or superior performance model is generated from a number of performances of PGS golf professionals. Such processes also include processes for deriving from the elite or superior performance model an individual performance model of a particular subject, such as a student, that represents his/her body specifications and his/her ideal or superior performance of a physical skill, such as a golf swing. The individual performance model is a standard model for that particular subject to which his/her actual performance of the skill, e.g., golf swings, may be compared. The performance models may be used to measure and analyze student movement skills for purposes of teaching and assessing performance improvement.

While these previously proposed patents make it easier for a student's performance to be compared to that of a superior or elite performer, the student will still require instruction to identify significant errors in their performance and to undertake the necessary corrective action. The student will also be reliant on the subjective opinion of their instructor when it comes to assessing the suitability and performance of their equipment, and recommendations for new equipment.

Embodiments of the invention disclosed herein provide systems and methods for processing the individual performance model, for evaluating and scoring a subject's performance of a physical skill, and for evaluating and fitting equipment used to perform the skill. In particular, embodiments of the present invention seek to alleviate the technical problem of how to process video data streams to automate the identification of errors in the performance of a task by a student, how to automate the indication of the corrective action to be undertaken by the student (preferably in terms that the student can understand) to avoid such errors, how to automatically assess the suitability and performance of equipment used by the student, and how to automatically determine items of equipment that might aid the student's performance.

### SUMMARY OF THE INVENTION

In general, in an aspect, the invention provides a method of providing a quantitative analysis of a subject's performance in undertaking a physical skill or task comprising: (i) obtaining a set of body measurements representative of one or more physical characteristics of the subject's body; (ii) modifying an elite performance data model representative of a body movement pattern associated with a superior performance of the skill or task in accordance with the set of the subject body measurements to provide a customized individual subject performance data model representative of the body movement pattern for an ideal performance of the skill or task by the subject; (iii) capturing video data of the subject undertaking the physical skill or task; (iv) determining from the captured video data a set of data representative of the subject's body movements while undertaking the skill or task; (v) identifying positional differences between body movements represented by the body movement data set derived from the video data, and body movements represented by the individual subject performance data model; and (vi) quantifying one or more of the identified positional differences to provide a quantitative analysis of the extent to which the body movement pattern of the subject while undertaking the skill or task differs from the body movement pattern represented by the individual subject performance data model, wherein a quantitative analysis of the subject's performance in undertaking the skill or task is provided.

Implementations of the invention may include one or more of the following features. The method of providing a quantitative analysis of a subject's performance in undertaking a physical skill or task further comprises reporting quantified positional differences. Reporting quantified positional differences comprises generating a score for one of: (i) one or more of each of the identified positional differences, and (ii) a group of the identified positional differences, that is representative of the extent to which the movement pattern of the subject while undertaking the skill or task differs from that represented by the individual subject performance data model.

The method further comprises setting a level of significance for the positional differences and selecting only those identified positional differences that exceed the set level of significance for reporting. Setting a level of significance for the positional differences and reporting only those identified positional differences that exceed the set level of significance. Reporting comprises retrieving from a data store and for each of the identified positional differences or a group of identified positional differences, one or more phrases that convey to the subject in the parlance of the skill or task being undertaken a reason for the difference between the subject's body movement pattern while undertaking the skill or task and that which is represented by the individual subject performance data model.

Implementations of the invention may further include one or more of the following features. The set of body measurements of the subject's body is derived from video images of the subject or from information provided by the subject. The method further comprises determining from the set of body measurements significant body-segment measurements, and further modifying the individual subject performance data model to account for limitations imposed upon the subject's ideal performance of the skill or task by the significant body-segment measurements.

The method further comprises deriving from the video data captured while the subject undertakes the skill or task, an equipment data set representative of equipment movement as the subject performs the skill or task. The method also comprises modifying an elite equipment data model representative of an equipment movement pattern associated with superior performance of the skill or task in accordance with the set of body measurements of the subject's body to provide a customized individual subject equipment performance data model representative of an equipment movement pattern for an ideal performance of the skill or task by the subject.

The method further comprises comparing the equipment data set derived from the video data captured while the subject performs the skill or task with the individual subject equipment performance data model, and identifying positional differences between equipment movements represented by the equipment movement data set derived from the video data, and equipment movements represented by the individual subject equipment performance data model. The method comprises quantifying any identified positional differences to provide a quantitative analysis of the extent to which the movement pattern of the subject's equipment while undertaking the skill or task differs from the individual subject equipment movement pattern represented by the individual subject equipment performance data model.

Implementations of the invention may also include one or more of the following features. The method further comprises generating a score for one of: (i) one or more of each of the identified differences, and (ii) a group of identified differences, that is representative of the extent to which the movement pattern of the subject's equipment while undertaking the skill or task differs from that represented by the individual subject equipment performance data model. In addition, the method comprises determining from the set of body measurements of the subject significant body-segment measurements, and further modifying the individual subject equipment performance data model to account for limitations imposed upon the equipment's ideal performance by the subject's significant body-segment measurements. Further, the method comprises determining a set of equipment fitting parameters from one or more of the identified and quantified differences, or from the modified individual subject equipment performance data model. The method may further comprise comparing said set of equipment fitting parameters with a set of stored equipment parameters to identify one or more items of equipment each of which has physical characteristics falling within or within a predetermined acceptable range of said fitting parameters.

In another aspect, the invention provides a computer program comprising one or more software program products operable, when executed in an execution environment, configured to implement at least: (i) modifying an elite performance data model representative of a body movement pattern associated with a superior performance of the skill or task in accordance with the set of the subject body measurements to provide a customized individual subject performance data model representative of the body movement pattern for an ideal performance of the skill or task by the subject; (ii) capturing video data of the subject undertaking the physical skill or task; and (iv) determining from the captured video data a set of data representative of the subject's body movements while undertaking the skill or task.

In a further aspect, the invention provides a system for providing a quantitative analysis of a subject's performance in undertaking a physical skill or task, the system comprising: one or more video capture devices for capturing video data of the subject undertaking the physical task; and a computer system comprising a processor, and one or more computer program products executable by the processor to: (i) modify an elite data model representative of a body movement pattern associated with a superior performance of the skill or task in accordance with a set of body measurements representative of one or more physical characteristics of the subject's body to thereby provide a customized individual subject performance data model representative of a body movement pattern for an ideal performance of the skill or task by the subject; (ii) capture video data of the subject undertaking the physical skill or task; (iii) determine from the captured video data a set of data representative of body movements of the subject while undertaking the skill or task; (iv) identify positional differences between body movements represented by the set of subject body movement data derived from the video data, and body movements represented by the individual subject performance data model; and (v) quantify any identified positional differences to provide a quantitative analysis of the extent to which the movement pattern of the subject while undertaking the skill or task differs from the movement pattern represented by the individual subject performance data model, wherein a quantitative analysis of the subject's performance in accomplishing the skill or task is provided.

In yet another aspect, the invention provides a computer program comprising one or more software elements operable, when executed in an execution environment, to: (i) modify an elite data model representative of a body movement pattern associated with a superior performance of a physical skill or task in accordance with subject body measurements representative of physical characteristics of a subject's body, and thereby provide a customized individual subject performance data model representative of a body movement pattern for an ideal performance of the skill or task by the subject; (ii) capture video data of the subject undertaking the physical skill or task; (iii) determine from the captured video data a set of data representative of subject body movements while undertaking the skill or task; (iv) identify positional differences between body movements represented by the set of body movement data derived from the video data, and body movements represented by the individual subject performance data model; and (v) quantify any identified positional differences to provide a quantitative analysis of the extent to which the movement pattern of the subject while undertaking the skill or task differs from the movement pattern represented by the individual subject performance data model, wherein a quantitative analysis of the subject's performance in accomplishing the skill or task is provided.

These and other advantages of the invention, along with the invention itself, will be more fully understood after a review of the following figures, detailed description, and claims.

### BRIEF DESCRIPTION OF THE DRAWINGS

FIG. 1 is an overall flow chart illustrating systems and processes of an embodiment of the invention disclosed herein;

FIG. 2 illustrates the components of a teaching system that may utilize the performance data and the performance models generated in accordance with an embodiment of the invention;

FIG. 3 is a flow diagram describing a Segment Trend Subroutine process for adjusting an individual performance model of a student to incorporate significant movement trends related to body segment length into the model;

FIG. 4 is a flow diagram describing a Performer Evaluation Subroutine process for generating an analysis of a student's performance;

FIG. 5 is a flow diagram describing a Performance Scoring Subroutine process for scoring the student's performance;

FIG. 6 is a flow diagram describing a Performance Errors Subroutine process for identifying the student's errors using the student's performance scores generated from the Performance Scoring Subroutine process; and

FIG. 7 is a flow diagram describing an Equipment Fitting Subroutine process for generating a quantitative analysis of equipment using the student's performance scores generated from the Performance Scoring Subroutine process.

### DETAILED DESCRIPTION OF PREFERRED EMBODIMENTS

A. General Description

Embodiments of the invention provide systems and methods for deriving computer generated performance data and performance models used to measure and analyze movement of a human body engaged in a physical skill or activity, and/or to measure and analyze movement of an implement or equipment involved in performing the skill or activity. In addition, embodiments of the invention provide systems and methods of teaching a physical skill or activity that incorporate the computer-generated performance data and performance models into processes for teaching the skill or activity and for assessing changes and improvements in performances of the skill or activity. Those of ordinary skill in the art will appreciate that the teachings provided herein can be applied to a wide variety of physical skills or activities involving human movement such as, for instance, track and field events, baseball pitching, baseball hitting, tennis service and any sports or other physical activity or skill. For purposes of illustrating the teachings of the invention, systems and methods of the invention are described hereafter in connection with the performance of golf skills and, in particular, with reference to a golf swing. It should be noted, however, that the scope of the invention is not limited solely to the sports described herein.

The terms subject, performer and student refer to a person undertaking a physical skill, task or activity, and such terms are used interchangeably. The term teacher refers to a person having the skill to notice and to help to correct or teach the abilities for and performance of a subject, performer or student undertaking a physical skill, task or activity.

Embodiments of the invention provide systems and methods for producing a computer generated individual performance model of a student performing a physical skill or activity, such as swinging a golf club. In a preferred embodiment, the individual performance model is derived from a computer generated, standardized elite or superior performance model determined from the superior performances of a predetermined number of elite performers, such as PGA golf professionals swinging a golf club. The elite or superior performance model is generated from the movement patterns of each elite performer. In addition, the elite or superior performance model is improved by comparing the movement patterns of elite performers with each other and with non-elite performers to identify significant trends of elite movement patterns that achieve superior results.

In a preferred embodiment, the individual performance model is essentially the elite or superior performance model that has been altered or adjusted to the exact specifications of a student to which the individual performance model is to be compared. The elite or superior performance model is adjusted to the body size and dimensions of a student to account for the physical differences between the elite or superior performance model and the student. The applicant has found that certain skeletal body segments provide an accurate representation of a student's body including, but not limited to, toe, heel, ankle, knee, hip, iliac, shoulder, elbow, wrist, hand, ears, nose and vertebral segments. The size and dimensions of these body segments are incorporated into the elite or superior performance model to size or scale the model to the individual student. The individual performance model thereby provides an individualized model that represents the student and his/her ideal or superior performance of the skill or activity.

The computer generated elite or superior performance model and the individual performance model are generated according to systems and processes disclosed in the applicant's prior patents, U.S. Pat. No. 4,891,748 and U.S. Pat. No. 5,184,295, which are incorporated herein in their entireties by reference and should be consulted, as necessary, for technical information regarding the preferred implementation of the teachings of the invention. The systems and methods of the embodiments disclosed herein further adjust the individual performance model to account for trends in body movement patterns elite or superior performers demonstrate that are related to the length of body segments involved in a physical skill or activity and that move elite performers toward achieving superior performance results.

The systems and processes disclosed in U.S. Pat. No. 4,891,748 and U.S. Pat. No. 5,184,295 that generate the elite or superior performance model and the individual performance model use a number of computer software programs referred to as Program A, Program B, Program C, Program D, and Program E. Additional software programs include a Digitize Program and Normalize Programs. The Programs are discussed in detail in U.S. Pat. No. 4,891,748 and U.S. Pat. No. 5,184,295 and will not be explained here. However, for purposes of information and continuity with respect to the teachings provided herein, a brief overview of each of the Programs is provided below.

Program A

A three-dimensional movement pattern for each elite performer, e.g., a PGA golf professional, is processed with Program A. Digitizing a film or video image of the elite performer accomplishing the skill or activity generates the three-dimensional movement pattern. The digitizing process involves quantifying all of the body segments involved in the movement pattern in four dimensions, e.g., horizontal, vertical, lateral and time, of the performer as they move through the skill performance from at least two image capture sources. If the skill includes equipment, the equipment segments are included in the digitizing process. Program A generates an individual model for each elite performer that is captured on a film or video file. The output of the Program is written to a storage file.

Program B

Program B uses the output of Program A and averages all of the individual models generated to produce an average model of elite performers. The average model includes the average movement pattern of the elite performers performing the skill or activity. Program B outputs a data file including the average model.

Program C

Program C reads the average model data from the Program B output data file and sizes each individual model generated in Program A to the average model of Program B. Program C produces an output file containing sized elite data.

Program D

Program D combines the sized individual models to produce an average elite model. Program D then identifies characteristics that elite performers employ for producing superior performances. Program D also identifies characteristics or trends that elite performers employ that are absent in non-elite performers. The identified characteristics are then incorporated into the average model to produce a superior or elite performance model.

Program E

Program E takes the superior or elite performance model from Program D and individualizes it to the body size of any performer or student. The performer's or student's body segment position sizing data generated from the digitize program described below are used to scale or size the elite or superior performance model to individualize the performance model to the body size of the performer or student and to thereby generate an individual performance model of the performer's or student's ideal performance. If any equipment is involved in the activity, the model equipment position results previously generated from Programs A thru D are incorporated into the superior or elite performance model.

Digitize Program

The digitize program includes capabilities to digitize critical body points of a student and scales the data collected in order to help build the student's individual performance model from the elite or superior performance model (generated with Programs A thru E). Two cameras are used to capture a video image of the student from a front or face-on view and from a side view. Each view is displayed on a graphic display interfaced with a computer on which the digitize program is loaded. The body points of the student from a front camera view and from a side camera view are digitized using the video image of the student displayed on the graphic display. The digitized program uses a scale file or, if a scale file is not available, generates a scale file using a scale factor for and in each camera's view. A scale factor may include placing a known dimensional object, e.g., a yardstick or a multi-segment scale factor, in the view of the camera for generating a scale. In each of the front and the side views of the student, the scale factor is displayed with the video image of the student, and the scale factor is then digitized. The necessary scale position points of the scale are digitized from the video image display. The number of points is determined by either the DLT method or 90° camera offset method. While generating the scale file information, the data are read into the computer and stored on a file. The scale factor results are entered to provide the sizing data to scale the student's results to full scale.

The student is placed in front of the front, or the side, video camera in a position that best allows all the body points to be seen by the camera. The video image of the student is displayed on the graphic display. Critical body segment points of the student are digitized using a mouse pointing device or a keyboard, wand or trackball interfaced with a video display card of the computer. The graphic results of the digitizing effort are displayed to ensure that the results are acceptable. If the points are not acceptable, the procedure is repeated. The digitized body points of the student are stored in a data file in the computer for use in the Programs noted above and described herein.

Normalize Programs

The prior patents teach three Normalize programs that normalize (match) the body segment values of the student and the model. Normalize-1 and Normalize-3 normalizes the model segment lengths to those of the student. Normalize-2 normalizes the student segment lengths to those of the model. These programs are used throughout the model building and fitting process to match the results between the student and the model performance.

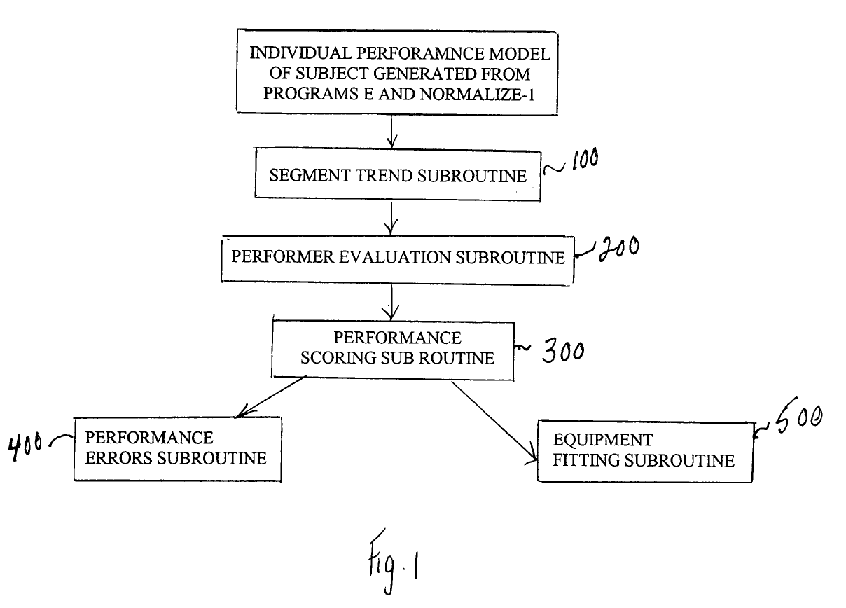

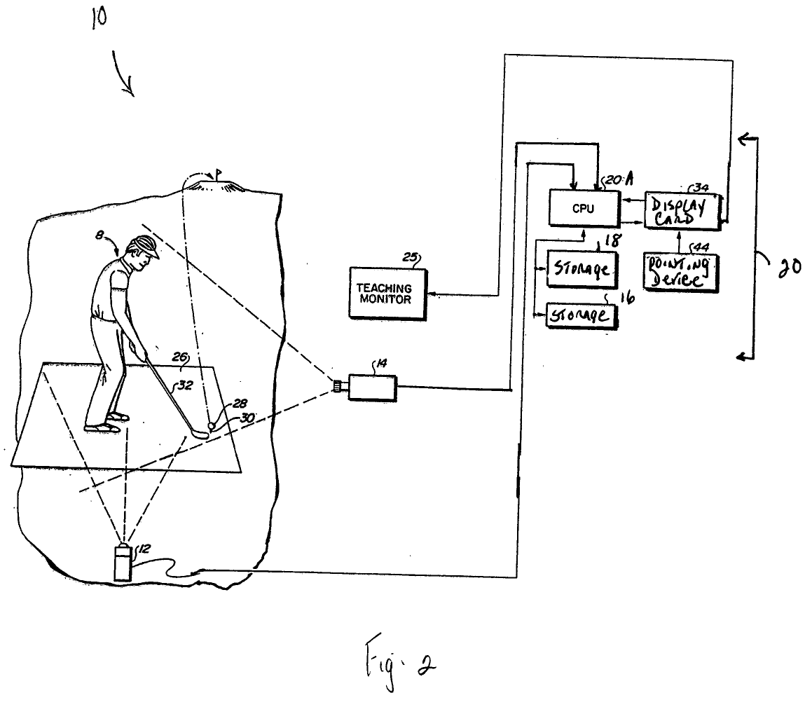

Referring to FIG. 1, in general, in an aspect, a preferred embodiment of the invention provides systems and processes for adjusting the individual performance model of a student generated from Programs E and Normalize-3 to alter or modify the model to account for significant trends of body movement patterns elite performers demonstrate that are related to body segment length. The preferred embodiment of the invention includes a computer software program referred to as a Segment Trend Subroutine 100 that conducts a process of altering or modifying the individual performance model to incorporate such trends into the model.

With further reference to FIG. 1, in general, in another aspect, a preferred embodiment of the invention provides systems and processes for generating a comprehensive, quantitative based performance analysis of a student performing a physical skill or activity. The preferred embodiment of the invention includes a computer program referred to as a Performer Evaluation Subroutine 200 that operates a process for collecting movement data of a student performing a skill or activity and comparing such movement data to corresponding information of the student's individual performance model generated from the Programs disclosed in U.S. Pat. No. 4,891,748 and U.S. Pat. No. 5,184,295 and from the Segment Trend Subroutine 100 disclosed herein. In addition, if an implement or equipment is used to perform the skill or activity, the Performer Evaluation Subroutine 200 comprises collecting equipment movement data and other equipment related results simultaneously along with student movement data, and comparing the movement data and other equipment results to corresponding information of the equipment in the student's individual performance model.

The Performer Evaluation Subroutine 200 further comprises three subroutine computer programs including a Performance Scoring Subroutine 300 that calculates a quantitative, statistical based performance score of a student's performance of a skill or activity. The Performance Scoring Subroutine 300 compares performance data of the student's performance with the corresponding performance data of his/her individual performance model and scores the differences between performances.

Other programs include a Performance Errors Subroutine 400 that identifies statistically significant performance errors in the student's performance using the scores derived from the Performance Scoring Subroutine 400 to provide a basis for evaluation of the student's performance. In addition, an Equipment Fitting Subroutine 500 is included that produces a quantitative equipment fitting to the individual student and his/her performance based upon equipment results and performance data.

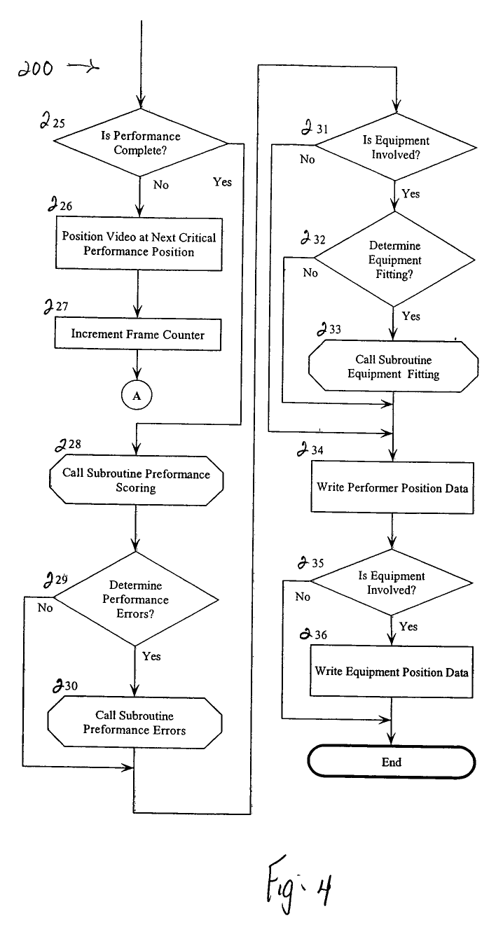

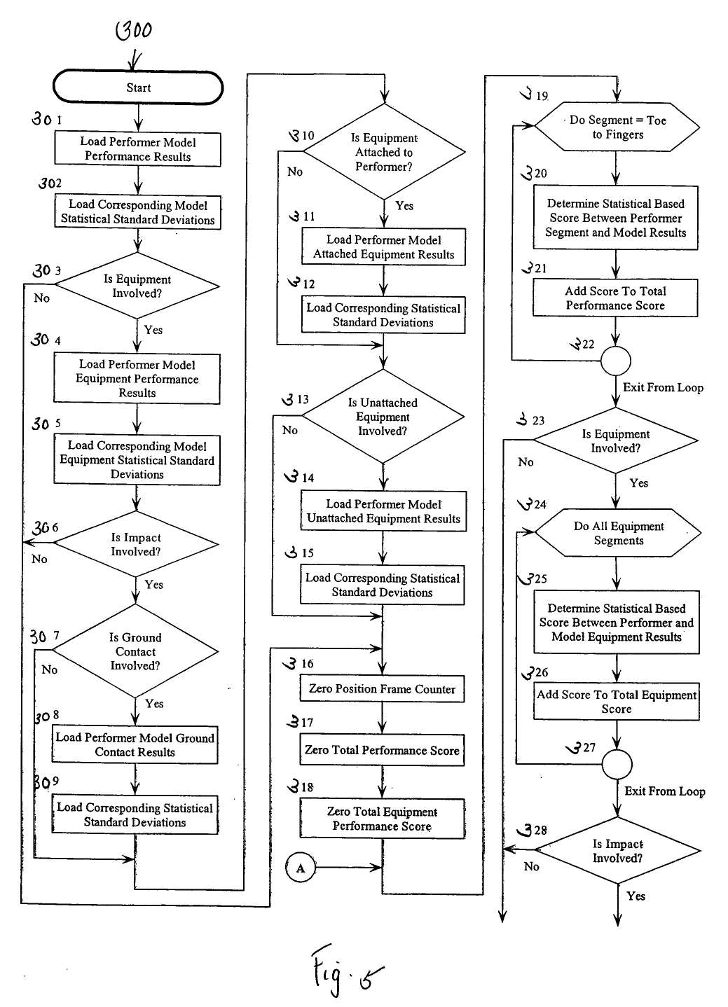

The Segment Trend Subroutine 100, the Performer Evaluation Subroutine 200, the Performance Scoring Subroutine 300, the Performance Errors Subroutine 400 and the Equipment Fitting Subroutine 500 are described below in detail with reference to FIGS. 3-7.

The individual performance model provides the quantitative information standard that is required to compare and analyze a physical skill or activity, e.g., a golf swing, of a student relative to his/her ideal or superior model performance. The subroutine processes described herein quantify the actual performance of the golf swing of a student by comparing the student's actual performance to his/her individual performance model. The results of the processes may be used for purposes of teaching, performance evaluation and equipment fitting. Each process uses a video record of a student's golf swing collected along with non-impact data related to the student's movement patterns. In addition, measured results related to the equipment, e.g. a golf club and golf ball, used to perform the skill or activity are collected simultaneously in real-time along with the video record to provide information relative to equipment performance results. From the video record, the images of the student's body segments and the equipment segments, e.g., shaft of the golf club, involved in the golf swing are quantified using the digitize process described above and referred to below. Thereafter, each subroutine computes an analysis to provide performance scores and/or to identify performance errors related to the student's actual golf swing and the equipment being used.

B. Hardware Description

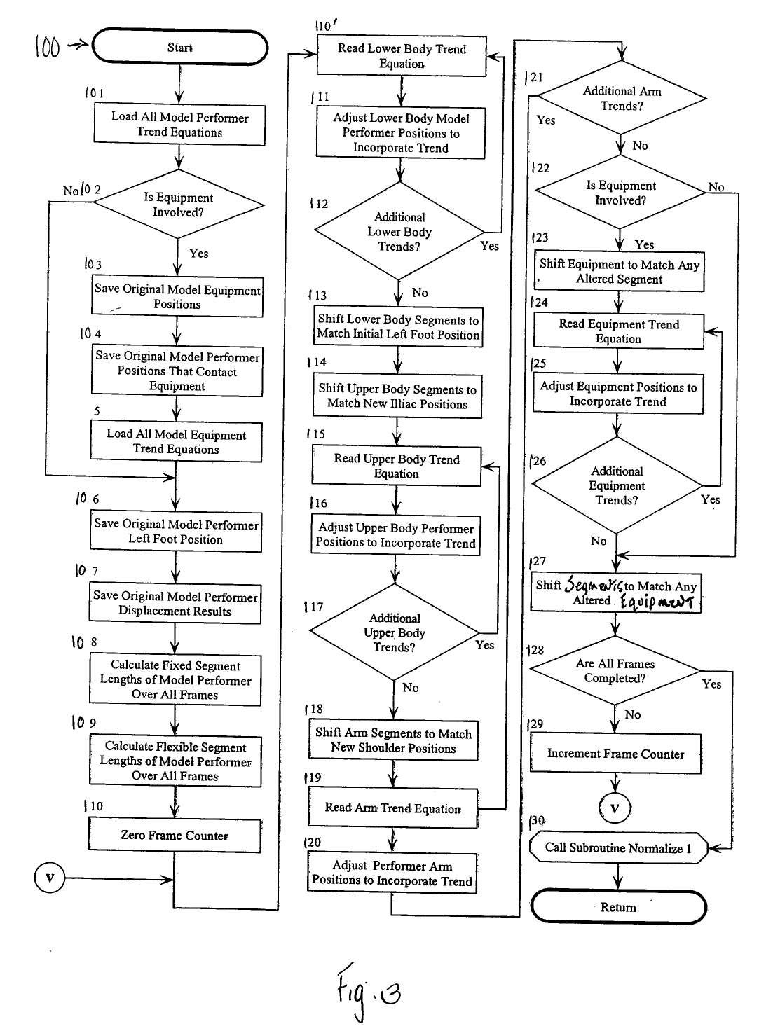

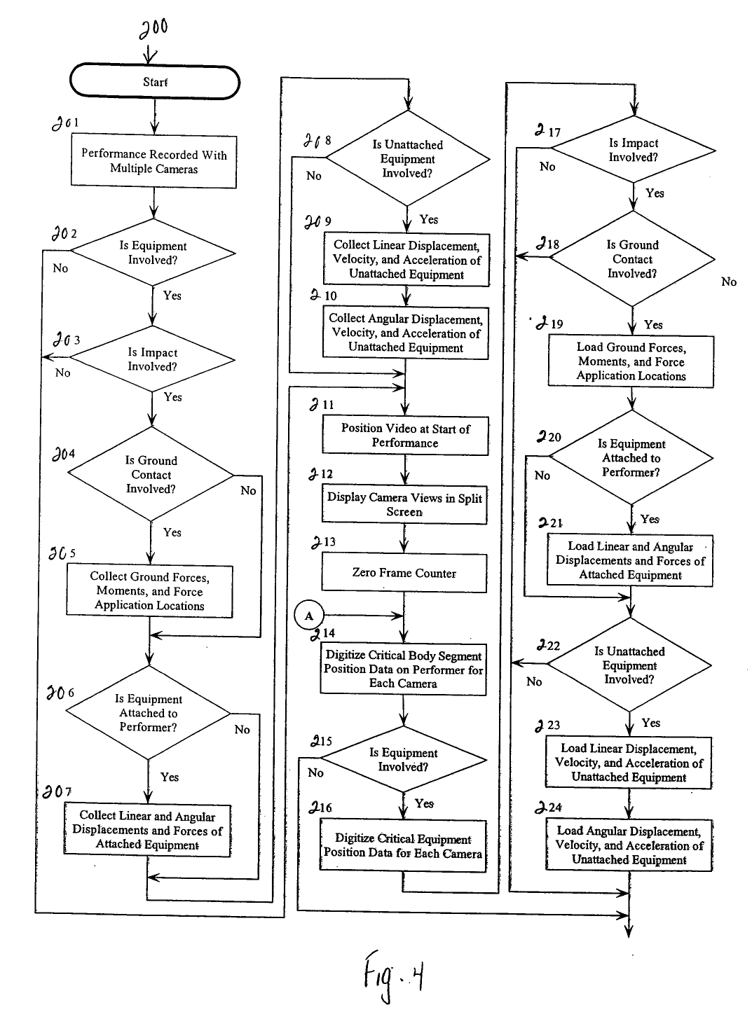

Referring to FIG. 2, in an aspect, a preferred embodiment of the invention provides a system 10 for providing instruction of a physical skill or activity. Components of the system are shown in FIG. 2 in operative positions and include a driving platform 26 that holds a tee 30 on which a golf ball 28 is positioned that a student 8 holding a golf club 32 will strike (impact). A digital video camera 14 records the front view position of the student 8 as he/she stands on the driving platform 26. The camera 14 passes digital images to a system computer 20 for capture on a hard drive storage device 18. Another digital video camera 12 records the side view of the student 8 as he/she stands on the driving platform 26. The camera 12 passes the digital images to the system computer 20 for capture on a hard drive storage device 16. Any number of cameras and hard drives can be used, however, applicant has found that two cameras and two hard drives (or one drive with two partitions) are sufficient to properly analyze a golf swing.

Digitizing the three-dimensional body positions of the student 8 requires two video cameras positioned to provide the necessary three coordinates of height, width and depth. One camera may be used if the student assumes two stance positions—one after the other. Once the body and/or the body segments of the student 8 are digitized, only one camera is needed for the on-line teaching or the video performance overlay teaching processes disclosed in U.S. Pat. Nos. 4,891,748 and 5,184,295 and described below. The single camera may be positioned for any view desired by an instructor and a student to view a teaching monitor 25. Two or more cameras may be used to improve the teaching process. Since the individual performance model can be generated from any viewing perspective, the video cameras 12 and 14 can be placed at any selected locations.

The video cameras 12 and 14 used in the preferred embodiment of this invention are digital shuttered video cameras for avoiding the problem of standard unshuttered video cameras that have a long exposure time. This extended exposure time produces a picture blur for any rapid movement of the student 8. The rapid movement produced by the golf swing requires a video camera that can capture the high-speed motion on the hard drive storage device 16 and 18 without the blur problem found in standard video cameras. The video cameras 12 and 14 capture at a minimum rate of 60 images per second of a student golfer in motion. The video cameras 12 and 14 used in the preferred embodiment of this invention are color, shuttered digital video cameras, such as the Flea model manufactured by the Point Gray Corporation of Vancouver, BC, Canada. These cameras are shuttered to provide at least 1/500 second exposure time in a manner well known in the art. The outputs from shuttered video camera 12 and 14 are fed respectively to the hard drive storage devices 16 and 18.

The outputs from the hard drive storage devices 16 and 18 are fed to the system computer 20 including a processor 20A and a video display card 34 of sufficient ability to display either or both recorded front and side view results. The video display card 34 overlays from one of the hard drive storage devices 16 or 18 a computer-generated individual performance model of the student's ideal or superior performance, which was previously determined as described above and stored in the respective hard drive storage device 16 and 18. The video display card 34 then displays the result on the teaching monitor 25 attached to the computer 20.

The computer 20 interfaces with a mouse-pointing device 44, providing the necessary input commands for moving a cursor to digitize a video image on the monitor 25. The computer 20 includes the software necessary for manipulating the image data, digitizing an image, and displaying the image in a manner well known to those skilled in the art. The mouse-pointing device 44 may be also replaced with a keyboard, or wand, or a trackball for digitizing purposes in a manner well known to those skilled in the art.

The computer 20 further includes the necessary hardware and logic including memory for manipulation of the data to determine a computer-generated model. The computer used in the preferred embodiment of this invention is the VIAO PCG-GRT390ZP manufactured by SONY Corporation of Tokyo, Japan. In the preferred arrangement, the programs configured to implement the teachings of the invention are in a language suitable for such computer.

Those of ordinary skill in the art will appreciate that other programmable general purpose computers of similar capability can be substituted for the VIAO PCG-GRT390ZP. Also, other languages may be used in such other machines for the programs. The programs set forth herein are in a machine code language from Visual C++ programs written for the Microsoft Windows based Operating System available from Microsoft Corporation of Redmond, Wash.

A number of programs are used in the preferred embodiment of this invention. The programs include those program(s) with capabilities to digitize the movements of a student or performer during an actual performance of a skill or activity such as a golf swing, and to perform a series of comparisons of these digitized data with the student's or performer's individual performance model to determine performance scores, performance errors, and equipment fitting. Additional program(s) have capabilities to display the results of these programs on a video monitor. SONY Corporation and Microsoft Corporation supplied various types of programs with the commercially available hardware. These later programs are executive systems, diagnostics, utilities, monitoring display programs, statistical programs and higher level programs available and will not be described herein. As noted above, the performance model generation programs are explained in detail in U.S. Pat. No. 4,891,748 and U.S. Pat. No. 5,184,295.

The computer 20 supplies the graphics card 34 with the necessary data for the graphics card 34 to generate a video image of a performance model. The graphics card 34 combines the input from the computer 20 and generates a display on the teaching monitor 25. The generated display includes the video image of the student 8 with an individual performance model overlayed on the student's image. Typically, the computer 20 and teaching monitor 25 are located near the student 8 such that the student 8 can easily watch the results of his/her golf swing.

C. Operation and Teaching Processes

The teaching system shown in FIG. 2 for teaching and evaluating a student performing a physical skill or activity includes generating the individual performance model and teaching the student using the on-line and/or the video overlay teaching and evaluation processes that are described below. Before teaching can take place, the individual performance model of the student must be generated from the elite or superior performance model. A brief description of the process of generating the individual performance model is provided below. For a more detailed description of this process, the disclosures of U.S. Pat. No. 4,891,748 and U.S. Pat. No. 5,184,295 should be consulted.

Briefly, generating an individual performance model begins with the input of the three-dimensional body positions of the student 8 into the computer 20. Video images of the student 8 are supplied using the two video cameras 12 and 14 to capture the front views and the side views of the student 8 and to provide the necessary coordinates of height, width and depth. The student 8 stands briefly in front of the cameras 12 and 14 so that all body segments are visible and can be scaled. Both the front and side views of the student 8 are recorded simultaneously on the hard drive storage devices 16 and 18. Each image is stored on the hard drive storage devices 16 and 18 for processing immediately or at a later time.

For each view, the video image of the student's performance is played back through the graphics board 34. Using the digitizing capabilities of the computer 20 and the graphics board 34, the body and equipment positions of the student 8 are digitized and stored for computer processing. In this manner, a three-dimensional digitized pattern of the student is obtained.

In lieu of a direct measurement of the student's body segments, such information may be determined from known measurement data supplied by the student, such as height, weight, shoe size, pant (trouser) length, waist size, jacket size, shirt sleeve length, and glove size.

After the student's body segment information has been determined, a three-dimensional individual performance model is computed from the elite or superior performance model by altering the elite or superior performance model to match the exact body dimensions of the student. In addition, all movement alterations or adjustments the student 8 must produce due to differences between the student's body segments and those of the superior performance model are accounted for and included in the individual performance model. After the individual performance model is generated, the on-line and/or video performance overlay teaching and evaluating processes can begin.

On-Line Teaching Process

The on-line teaching process allows a student to compare his/her positions or movement patterns with his/her individual performance model that overlays a video image of his/her actual performance to demonstrate the similarities and differences between the actual and model performances. The on-line teaching process is used in stationary positions, for instance, at the setup or beginning position in golf, where a teacher can identify the differences between the individual performance model and the student and make immediate changes. For the student's positions that are reached while moving or performing a physical skill or activity, the student can be placed in a stationary position to demonstrate the feel of the position or the student can perform the activity while the teacher watches a monitor on which the individual performance model is displayed over the video image of the student's actual performance to determine whether the selected positions are being reached. At any time, the video image generated at the teaching site can be switched to another view, or multiple views, with the individualized performance model switching to the correct position at the same time. An added advantage is immediate checks on meeting the goals of a lesson. If a movement pattern occurs too fast or a teaching session is to be saved, the video results from the computer can be saved on the hard drive storage devices for immediate review. The on-line teaching process is described in greater detail in U.S. Pat. No. 4,891,748 and U.S. Pat. No. 5,184,295.

Video Overlay Performance Teaching Process

The video overlay performance teaching process involves producing a hard copy of the video record of a performance of a student as the student normally would attempt to accomplish a physical skill or activity with an overlay of his/her individual performance model superimposed over the video image of the student's performance. For instance, in golf, the process involves video recording the normal golf swing of a student as he/she attempts to drive the ball, e.g., at a target. The individual performance model scaled to the student is overlayed on the student's video image for the student to compare his/her swing to his/her performance model's swing. This result may then be sent to a permanent storage device to allow a teacher and/or a student to review the results at a later time. The storage device may include, but is not limited to, a local or Internet based computer, recording devices, such as DVD, CD or video tape, or other such device. The video overlay performance teaching process is described in greater detail in U.S. Pat. No. 4,891,748 and U.S. Pat. No. 5,184,295.

D. Software Description

Referring to FIG. 3, a flow diagram is provided that describes a process 100 referred to as the Segment Trend Subroutine for generating an individual performance model of a student that is adjusted or modified for the performance limitations imposed by the size and dimensions of the student's body segments. Trend values related to significant body movement adjustments or movement patterns elite performers demonstrate due to differences in body segment length are incorporated into the individual performance model using the Segment Trend Subroutine 100 to produce a more complete and accurate individual performance model of a student's ideal or superior performance of a physical skill or activity. The individual performance model generated from the Segment Trend Subroutine process 100 may be used in either or both of the teaching methods described above.

For instance, in golf, alteration or modification of the individual performance model in accordance with the Segment Trend Subroutine process 100 accounts for the statistically significant body movement trends demonstrated by PGA golf professionals due to the differences in individual body segments and the complex interactions between such body segments. Significant body movement trends the applicant has identified represent those adjustments or alterations of body movements and movement patterns that elite performers demonstrate that are related to body segment length and move toward achieving superior results. Trend analyses of body movements and movement patterns consider a number of body segments including, but not limited to, hand, lower arm, upper arm, shoulder, upper trunk, lower trunk, hip, upper leg, lower leg, foot. In addition, combinations of body segments including, for instance, an entire arm, trunk or leg are analyzed for movement trends related to segment length. Performance data representing such body movement trends generate relatively precise movement values that are incorporated into the elite or superior performance model, generated from Programs E and Normalize-3 described above, using the Segment Trend Subroutine process 100.

The body segment trend approach thereby derives from the elite or superior performance model an individual performance model of a student's ideal or superior performance that accounts for performance alterations and/or limitations due to the student's body segment lengths. With respect to a golf swing, for instance, the body segment trend approach accounts for the differences in the path of a club head of a golf club that are the result of differences in the height of students. For instance, the applicant has noted from body segment trend analyses that from a back view of a student, and looking down a target line, as the height of students becomes shorter, the path of the club head becomes naturally flatter relative to and along a horizontal axis. In addition, such body segment trend analyses indicate that as the height of students becomes taller, the club head path becomes naturally more upright relative to and along a vertical axis.

In another instance, the applicant has found from body segment trend analyses that differences in the length of a backswing of a golf club are a result of differences in individual body segments. Such analyses indicate from a front or face-on view of a student swinging a golf club that a student with shorter body segments will have a backswing with a relatively long length, while a student with longer body segments will have a backswing with a relatively short length.

The Segment Trend Subroutine process 100 described in detail below with reference FIG. 3, however, is exemplary and not limiting. The process 100 can be altered, e.g., by having “blocks” added, removed or rearranged.

As shown in FIG. 3, the process 100 starts at block 101 with the computer 20 reading or loading equations for movement pattern trends related to elite or superior performer body segment length. The trend equations for body movement patterns are derived through statistical trend analyses on a population of elite or superior performers, e.g., a predetermined number of PGA golf professionals, whose performances are used to generate an elite or superior performance model. A generalized equation that may represent body movement trends related to body segment length includes:

$${SMV}_{T} = {SMV}_{C} + {\sum }_{i = 1}^{n} ( {pmt}_{i} * {SSR}_{C} )$$

where
SMV_{T}=Student Movement Value after a movement trend is applied;
SMV_{C}=Current Student Movement Value before a movement trend is applied;
i=component of movement trend being processed;
n=number of movement trends;
pmtᵢ=Performance movement trend constant; and

SSR_{C}=Student Segment Result derived from difference between a body segment length of a student and a body segment length of the elite performance model.

For instance, using the above equation, if the movement trend involves lateral position of the right hand of a golfer at the top of the swing, as it relates to body height, the new lateral position or Student Movement Value (SMV_{T}) would be determined by beginning with the current lateral position or Current Student Movement Value (SMV_{C}), then adding the lateral alterations imposed by all of those body segments involved in the movement trend (SSR_{C}), multiplied by the movement trend constant (pmtᵢ), which is the contribution of the involved body segments to the lateral shift. The movement trend constant (pmtᵢ) is determined using statistically derived regression analysis of elite or superior trend performances, e.g., of PGA golf professionals.

Thus, for a golfer of less than average height, after adding the trend changes imposed by the differences in segment lengths of the shorter golfer with the elite or superior performance model, the right hand will shift the determined distance laterally (away from the ball). This right hand lateral shift is one of the known height related performance trends in the golf swing.

The Movement Values may be any aspect of the performance, such as body segment velocity, or combinations of various aspects of the performance, such as combinations of linear or angular displacement, velocity, or acceleration values. In addition, the Movement Values may encompass any of the student body segments, or combinations thereof. The component of the movement trend being processed (i) may include, for instance, a body segment involved in the movement trend.

At block 102, a query presents to ask if an implement or equipment, e.g., a golf club, is involved or required to perform the activity or skill, e.g., swinging a golf club.

If the answer to the query at block 102 is yes, the process 100 proceeds to block 103, and the original positions of the implement or equipment used during the performance of the individual performance model are saved in the computer throughout the performance to ensure that the positional demands of the implement or equipment are returned to the model's performance after the model has been altered according to this subroutine.

If the answer to the query at block 102 is no, the process 100 proceeds to block 106.

At block 104, the original positions of any body segments of the individual performance model that contact the implement or the equipment piece during performance of the skill or activity are saved in the computer throughout the model's performance to insure that the performer-equipment interface is properly replaced in the model's performance after the model has been altered.

At block 105, the computer 20 reads or loads equations for all elite performer segment length related trends for equipment. The trend equations for equipment are derived through statistical trend analyses on the population of elite or superior performers, e.g., a predetermined number of PGA golf professionals, to determine movement trends due to equipment segment length. A generalized equation that may represent equipment movement trends related to equipment segment length includes:

$${SEV}_{T} = {SEV}_{C} + {\sum }_{i = 1}^{n} ( {pmt}_{i} * {SSR}_{C} )$$

where
SEV_{T}=Equipment Movement Value after the movement trend is applied;
SEV_{C}=Current Equipment Movement Value before the movement trend is applied;
i=component of movement trend being processed;
n=number of trend components;
pmtᵢ=Performance movement trend constant; and
SSR_{C}=Student Segment Result derived from difference between a body segment length of a student and a body segment length of the elite performance model.

For instance, using the above equation, if the equipment performance trend involves the horizontal position of the butt of the club of a golfer at the top of the swing, as it relates to body height, the new horizontal position (SEV_{T}) would be determined by beginning with the current horizontal position (SEV_{C}), then adding the horizontal alterations imposed by all of those body segments involved in the trend (SSR_{C}) multiplied by the movement trend constant (pmtᵢ), which is the contribution of the involved body segments to the horizontal shift. As noted above, the movement trend constant (pmtᵢ) is determined using statistically derived regression analysis of elite or superior trend performances, e.g., of PGA golf professionals.

Thus, for a golfer of less than average height, after adding the trend changes imposed by the differences in segment lengths of the shorter golfer with the standard performance model, the butt of the club will shift the determined distance horizontally (toward the target—a longer swing), which is one of the known height related performance trends in the golf swing.

The Movement Values may be any aspect of the performance, such equipment segment velocity, or combinations of various aspects of the performance, such as combinations of linear or angular displacement, velocity, or acceleration. In addition, the Movement Values may encompass any of the equipment segments, or combinations thereof. The component of the movement trend being processed (i) may include, for instance, each equipment segment involved in the movement trend.

To return the final altered model or the final individual performance model of a student generated by this subroutine to an original starting reference position, an original left foot position of the model's performance is saved in the computer at block 106. To ensure that the original performance results are available for use in the trend equations, the original model performance positions are saved in the computer throughout the performance at block 107.

Because all trend equations entered into the computer 20 are based on a student's body segment lengths and an implement's or equipment piece's segment lengths, all fixed student body and fixed implement/equipment segment lengths are calculated over all frames of a performance video record of the student at block 108. In addition, all flexible student body and flexible implement/equipment segment lengths are calculated over all frames of the performance videotape of the student at block 109. If the student's body segment results are available from the body segment digitizing process, described above and in U.S. Pat. No. 4,891,748 and U.S. Pat. No. 5,814,295, the calculated body segment results are compared with the digitized values to verify the results. If the body segment data were obtained from another input, e.g., a measurement of shoe size, pant length, etc., then these calculated body segment results are used exclusively.

To begin alteration of the student's individual performance model, the subroutine process 100 initializes or zeros a frame counter at block 110. At block 110′, the computer 20 reads or loads an equation for a lower body movement trend.

For instance, the student body width trend that affects the horizontal right toe position (stance width) of a golfer may be calculated by summing the width-altering contributions of some or all of the lower body segments, e.g., feet, lower legs, upper legs, hips or iliacs. These alterations are then added to the current model position to incorporate the trend.

At block 111, positions of all of the lower body segments are adjusted to incorporate the lower body movement trend. In the instance above, if the right toe is shifted, the attached body segments must also be moved to place them in the same relative position, with respect to the toe, that such body segments occupied before the shift occurred.

At block 112, a query presents to ask if additional lower body movement trends are to be incorporated into the model to adjust the positions of the involved lower body segments. If the answer to the query is yes, the computer 20 reads the equation for a lower body movement trend at block 110′ and further adjusts the positions of each involved lower body segment of the model at block 111 until each lower body movement trend is incorporated into the model.

In the instance above, after the toe horizontal position has been adjusted, any other trends that affect the movement trends of the toe are incorporated. Once this has been completed, all of the other lower body segment components are processed.

If the answer to the query at block 112 is no, the process 100 proceeds to block 113 described below.

To ensure that the left foot position of the adjusted performance model matches its original left foot position, at block 113, the lower body segments are repositioned or shifted to match the original left foot position. If the lower body segment lengths of the student differ greatly from those of the typical elite performer used to generate the performance model, the shift distance may be large enough to decrease the improvements achieved through the trend adjustments.

At block 114, the positions of the upper body segments of the performance model are adjusted or shifted to reposition each of the involved upper body segments in relation to the new lower body segment positions. For instance, if the two iliac are shifted forward by about two inches during the downswing in golf, then all of the upper body segments are automatically shifted forward by two inches during this movement as the upper body is repositioned onto the new lower body position.

At block 115, the computer 20 reads or loads an equation for an upper body movement trend. For instance, the student body width trend that affects the horizontal left shoulder position at the top of the swing, which affects shoulder turn of a golfer, may be calculated by summing the width-altering contributions of some or all of the lower body segments, e.g., feet, lower legs, upper legs, hips or iliacs, and some or all of the upper body segments, e.g., vertebral segments, shoulders, neck, or head. These alterations are then added to the current model position to incorporate the trend.

At block 116, positions of all of the upper body segments are adjusted to incorporate the upper body movement trend. In the above instance, if the left shoulder is shifted, the attached body segments must also be moved to place them in the same relative position, with respect to the shoulder, that they occupied before the shift occurred.

At block 117, a query presents to ask if additional upper body movement trends are to be incorporated into the model to adjust the positions of the involved upper body segments. If the answer to the query is yes, the process 100 proceeds to block 115 and reads the equation for an additional upper body movement trend. At block 116, further adjustments to positions of each involved upper body segment of the model are made until each additional upper body movement trend is incorporated into the model. In the instance above, after the shoulder horizontal position has been adjusted, any other trends that affect the movement of the shoulder are incorporated. Once this has been completed, all of the other upper body segment components are processed.

If the answer to the query at block 117 is no, the process 100 proceeds to block 118 described below.

At block 118, the positions of the arms of the individual performance model are adjusted in relation to the new shoulder positions to incorporate the upper body movement trend. For instance, if the two shoulder points are rotated an additional 10 degrees during the backswing in golf, then all of the arm segments are automatically shifted to the new shoulder positions.

At block 119, the computer 20 reads or loads an equation for an arm movement trend. For intance, the student body segment length trend that affects the horizontal left hand position at ball impact of a golfer may be calculated by summing the length-altering contributions of some or all of the lower body segments, e.g., feet, lower legs, upper legs, hips or iliacs, and some or all of the upper body segments, e.g., vertebral segments, shoulders, neck or head, and some or all of the arm segments, e.g., upper arms, lower arms or hands. These alterations are then added to the current model position to incorporate the trend.

At block 120, positions of the arm segments of the individual performance model are adjusted to incorporate the arm movement trend. In the instance above, if the left hand is shifted, the attached body segments must also be moved to place them in the same relative position, with respect to the hand, that they occupied before the shift occurred.

At block 121, a query presents to ask if additional arm movement trends are to be incorporated into the model to adjust the positions of all involved arm segments. If the answer to the query is yes, the process 100 proceeds to block 119 and block 120, respectively, and reads the equation for an arm movement trend and adjusts positions of each involved arm segment of the model until each additional arm movement trend is incorporated into the model. In the instance above, after the left hand horizontal position has been adjusted, any other trends that affect the movement of the hand are incorporated. Once this has been completed, all of the other arm segment components are processed.

If the answer to the query at block 121 is no, the process 100 proceeds to block 122 described below.

At block 122, a query presents to ask if an implement or equipment is involved in performing the activity of skill. If the answer to the query is yes, the process 100 proceeds to block 123. If the answer to the query is no, the process 100 proceeds to block 127.

At block 123, positions of certain segments of the implement or equipment involved in the skill or activity are adjusted or shifted to match any of the new or altered positions of each lower and/or upper body segment to help to ensure that a performer-equipment interface in the individual performance model is maintained. For instance, if the process 100 has shifted the performance model's hands laterally by one inch, a corresponding portion of the equipment must be shifted about an equal amount to place the equipment back in the hands of the performance model to restore the performer-equipment interface.

The computer 20 reads or loads an equation for an implement or equipment trend at block 124. For instance, the student body segment length trend that affects the angular position of the club shaft, e.g., tilt of the club, at ball impact of a golfer may be calculated by summing the length-altering contributions of some or all of the lower body segments, e.g., feet, lower legs, upper legs, hips or iliacs, some or all of the upper body segments, e.g., vertebral segments, shoulders, neck or head, and some or all of the arm segments, e.g., upper arms, lower arms or hands. These alterations are then added to the current model position to incorporate the trend.

At block 125, positions of the involved segments of the implement or equipment are adjusted to incorporate an equipment movement trend at block 125. In the instance above, if the club shaft position is shifted, the attached segments must also be moved to place them in the same relative position, with respect to the hand, that they occupied before the shift occurred.

At block 126, a query presents to ask if additional equipment trends are to be incorporated into the model to adjust the positions of the involved implement or equipment segments. If the answer to the query is yes, the process 100 proceeds to block 124 and reads the equation for an equipment trend.

At block 125, positions of the implement or equipment segments involved are adjusted until each additional equipment trend is incorporated into the model. In the instance above, after the club shaft angular position has been adjusted, any other trends that affect the movement of the shaft are incorporated. Once this has been completed, all of the other equipment components are processed.

If the answer to the query in block 126 is no, the process 100 proceeds to block 127 described below.

At block 127, positions of the student's body segments in contact with the equipment are adjusted or shifted to reposition each segment to adjust to the new or altered positions of each equipment segment. Such adjustment may lead to further adjustment of additional body segments that are directly affected by the body segments that are in contact with the equipment. For instance, the club shaft is shifted, the attached segments must also be moved to place them in the same relative position, with respect to the shaft, that they occupied before the shift occurred.

At block 128, a query presents to ask if all frames have been completed. If the answer to the query is yes, the performance movement, e.g., golf swing, has been completed and the process 100 proceeds to block 130. If the answer is no, the process 100 proceeds to block 129.

At block 129, the frame counter is incremented, and the process 100 of adjusting the next frame of the performance model's movement is begun.

At block 130, the process 100 prompts a Subroutine Normalize-1 program to begin. The Subroutine Normalize-1 program proceeds to re-normalize body segment and implement/equipment segment position data to match the average body segment size of the model itself. The program essentially standardizes the segment lengths of the individual performance model throughout the performance using the standardized segment lengths of the elite or superior performance model as guidelines. This eliminates any segment position errors that were introduced during the trend integration process 100.

The process 100 may then return to a main program.

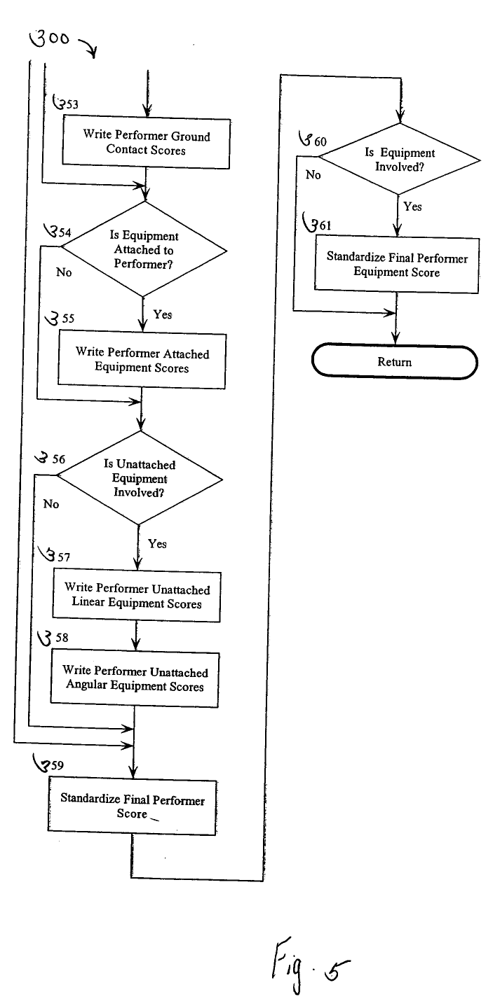

Referring to FIG. 4, a flow diagram is provided that describes a process 200 referred to as the Quantitative Performer Evaluation for generating a comprehensive, qualitative based performance analysis of a student performing a skill or activity. The process 200 comprises collecting movement data of a student performing a skill or activity and comparing such movement data to corresponding information of the student's individual performance model generated from Programs E and Normalize-3 disclosed in U.S. Pat. No. 4,891,748 and U.S. Pat. No. 5,184,295 and the Segment Trend Subroutine process 100 disclosed herein. In addition, if an implement or equipment is used to perform the skill or activity, the process 200 comprises collecting equipment movement data and other equipment related results simultaneously along with student movement data. This process 200 includes collecting a video record of the student performing the skill or activity and quantifying the performance.

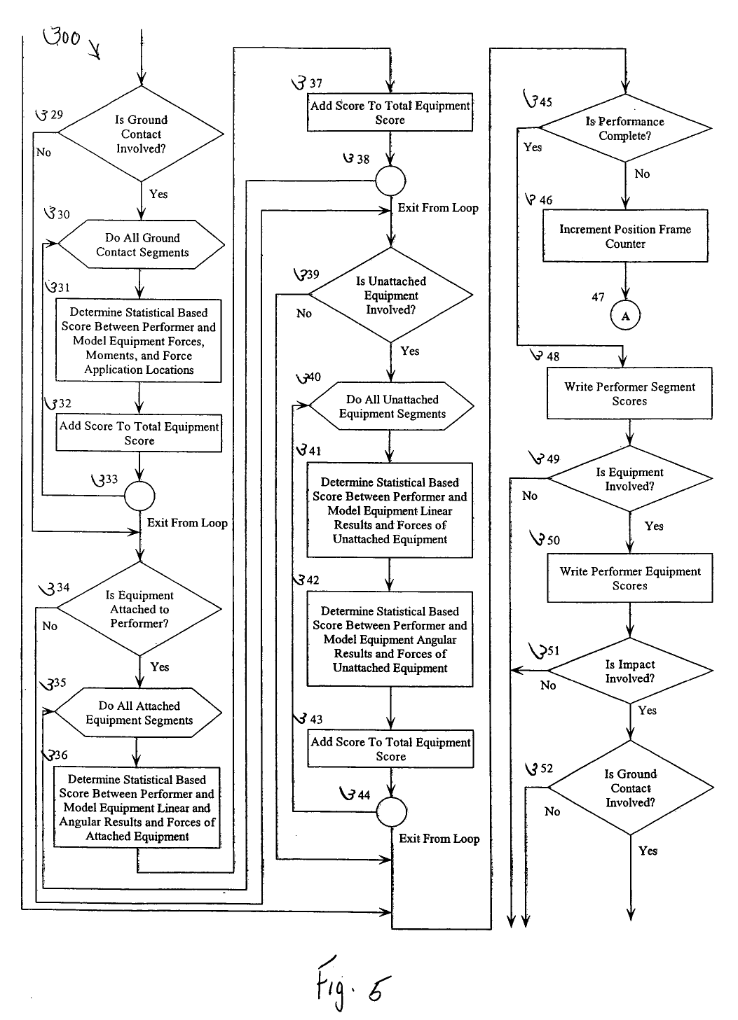

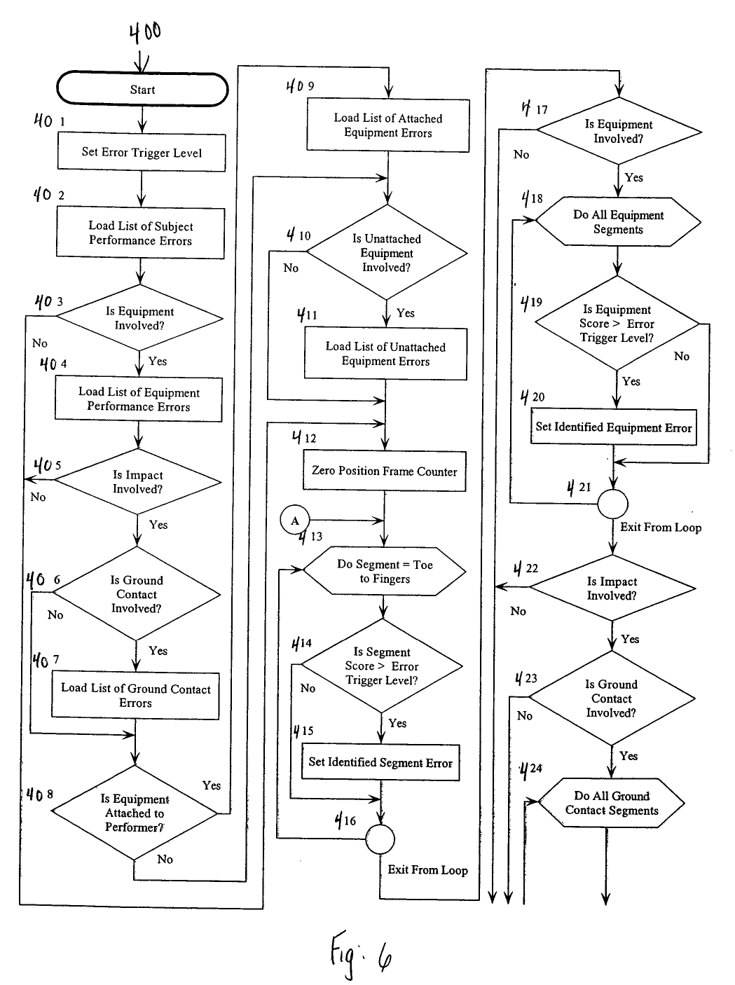

The process 200 further includes three subroutine processes, each to be described in detail below with reference to FIGS. 5-7, including the Performance Scoring Subroutine process 300 that calculates a quantitative, statistical based performance score of a student's performance of a skill or activity; a Performance Errors Subroutine process 400 that identifies statistically significant performance errors in the student's performance; and an Equipment Fitting Subroutine process 500 that produces a quantitative, research based equipment fitting to the individual student and his/her performance.

The Quantitative Performer Evaluation process 200 described below, however, is exemplary and not limiting. The process 200 can be altered, e.g., by having “blocks” added, removed or rearranged.

At block 201, the process 200 starts with capturing and recording a student's performance of a skill or activity, e.g., a golf swing or other movement, using at least two video cameras such as, for instance, the video cameras 12 and 14 described above. With respect to a golf swing, a first video camera 14 records the front views of a student 8 as he/she stands on a driving platform 26. As described above, the first video camera 14 is connected to a system computer 20 that stores the video record on a hard drive storage device 16. A second video camera 12 records the side view of the student 8 and is also connected to the computer 20 that stores the video record on a hard drive storage device 18.

At block 202, a query presents to ask if equipment is involved in the skill or activity. If the answer to the query is yes, the process 200 proceeds to block 203. If the answer is no, the process 200 proceeds to block 211.

At block 203, a query presents to ask if an impact is involved in the skill or activity. The impact(s) may consist of the student 8 contacting the driving platform 26 or the ground with his/her own body own segment or a piece of equipment, or striking another object with his/her own body segment or a piece of equipment. If the answer to the query is yes, the process 200 proceeds to block 204. If the answer is no, the process 200 proceeds to block 211.

At block 204, a query presents to ask if the student 8, or his/her equipment, has contact with the ground or the driving platform 26 during performance of the skill or activity. If the answer to the query is yes, the process 200 proceeds to block 205. If the answer is no, the process 200 proceeds to block 206.

At block 205, datum sets of ground contact information are collected throughout the performance of the skill or activity using devices and methods known collectively in the art as force platform collection technology. For instance, a commercially available force platform or plate on which the student 8 may stand includes the Kistler Force Plate manufactured by the Kistler Corporation of Winterthur, Switzerland. Such technology involves positioning a force platform or plate beneath the student 8 during performance of the skill or activity. The platform or plate and/or other associated devices and methods record and/or measure such contact information as ground forces, moments and locations of force applications. Ground forces include the linear vertical, lateral or horizontal forces exerted by the student 8 on the ground in an effort to alter the straight-line movement of him/herself, his/her equipment and/or an outside object. Moments include the angular forces exerted by the student on the ground in an effort to alter the rotational movement of him/herself, his/her equipment and/or an outside object. The location of force application includes the point(s) of force application(s). For instance, when a student steps on the ground with his/her toe, linear and angular forces are immediately exerted on the ground, with the point of force application being the location where the toe contacts the ground. Ground contact information may be of interest for a number of reasons including, but not limited to, golf shoe selection and injury evaluation.

A query presents at block 206 to ask if an implement or equipment is attached to the student during performance of the skill or activity. If the answer to the query is yes, the process 200 proceeds to block 207. If the answer is no, the process 200 proceeds to block 208.

At block 207, if an implement or equipment is attached to the student during performance of the skill or activity, performance data may be collected using applicable devices and methods. For instance, if the attached equipment is a golf club, devices and methods known collectively in the art as stress/strain collection technology may be attached to the shaft of the golf club to collect datum sets that include linear and angular displacement data and linear and angular force data. This technology measures how the equipment reacts to the forces the student 8 exerts, which can push (stress) and pull (strain) on the equipment. These forces result in the equipment bending and turning during performance of the skill or activity. The bending of the equipment results in linear motion, while the turning of the equipment creates angular movement. For instance, such technology includes the Kistler Stress/Strain measurement devices, manufactured by the Kistler Corporation of Winterthur, Switzerland. Such data may be collected throughout the performance of the skill or activity. For instance, if the performance of a certain shaft of a golf club is of interest, with the goal of determining the best golf club shaft utilizing the Equipment Fitting Subroutine Program 500 described below, the stress/strain collection technology attached to the golf club during the student's swing may collect certain data such as shaft flexion and rotation.

In many instances, the linear and angular movement data of a specific portion of the equipment attached to the student is desired. For instance, the impact may involve an implement, such as a golf club (attached equipment), used to strike another object, such as a golf ball (unattached equipment). The golf club head-ball interaction may be of interest to determine the most effective club head for a particular student. The impact or the golf club head-ball interaction and the results of such impact can be recorded and measured with various collection devices and methods that are known collectively in the art as launch monitor technology. For instance, such technology includes the Vector Launch Monitor manufactured by AccuSport, Inc. of Winston-Salem, N.C. Such technology records and measures club impact characteristics, such as, but not limited to, club head speed (velocity) at impact in three dimensions and club rotation along two axes. In addition, other devices and methods used to record and measure the club head-ball impact and the results of such impact include, but are not limited to, laser, photographic, photoelectric and pressure devices and methods.

If the answer to the query in block 206 is yes, several datum sets of the golf club head-ball impact are collected at block 207 during the performance of the skill or activity, including those noted here, as well as other results determined from these base data, such as effective loft and face impact position. Regardless of the devices and/or methods used to collect and measure impact characteristics, the impact results should include measurement of: (1) position and speed of the attached implement, such as a golf club, involved in three dimensions; and (2) angular position and rotation of the implement involved in three dimensions. The process 207 then proceeds to block 208.

At block 208, a query presents to ask if unattached equipment is used during the performance of the skill or activity. If the answer to the query is yes, the process 200 proceeds to block 209 and block 210, and if the answer is no, the process 200 proceeds to block 211.

At block 209, if unattached equipment is used, such devices and/or methods known collectively in the art as high-speed position collection technology can collect datum sets of performance results of the golf ball. For instance, the impact may involve an implement, such as a golf club (attached equipment), used to strike another object, such as a golf ball (unattached equipment). The golf club head-ball interaction may be of interest to determine the most effective golf ball for a particular student. As described above, the impact or the golf club head-ball interaction and the results of such impact can be recorded and measured with launch monitor devices and methods. Launch monitor devices and methods record and measure ball impact characteristics including, but not limited to, ball speed in three dimensions and ball rotation along two axes.

If the answer to the query in block 208 is yes, several datum sets of the golf club head-ball impact are collected at block 209 during the performance of the skill or activity, including those noted here, as well as other results determined from these base data, including, but not limited to, ball launch angle, flight time, ball height, and horizontal and lateral air and ground distance. Regardless of the devices and/or methods used to collect and measure impact characteristics, the impact results should include measurement of: (1) position and speed of the unattached implement, such as a golf ball, involved in three dimensions; and (2) angular position and rotation of the implement involved in three dimensions. The process 200 then proceeds to block 210.

At block 210, high-speed position collection technology can collect datum sets of performance results including angular displacement position data and angular velocity and acceleration data of the golf ball.

With the conclusion of the performance of the skill or activity, at block 211, the recorded video performance is positioned at the start of the performance.

At block 212, the first and the second video recorders play back video images through video decoder means 22 to display both the first or front facing positions of the student and the side positions of the student on a single display monitor 25 in a split screen format.

At block 213, a frame counter is initialized or zeroed.

At block 214, the video record of the student's performance of his/her golf swing is quantified. The positions of the student's body segments involved in the golf swing are collected for the front camera views and for the side camera views by digitizing the locations of critical body joints or points in the video images. The digitizing capabilities of the computer 20, described above and shown in FIG. 1, are used to digitize and store for immediate or later computer processing the positions of the student's body segments. The digitizing process may employ either a direct linear transformation method or a 90° camera offset method, as described above and in detail in U.S. Pat. No. 4,891,748 and U.S. Pat. No. 5,184,295.

At block 215, a query presents to ask if equipment is involved. If the answer to the query is yes, the process 200 proceeds to block 216. If the answer is no, the process 200 proceeds to block 225.

The positions of the implement or equipment are collected at block 216 by digitizing the critical equipment point locations from each of the front and the side camera views. The digitizing process may employ those methods noted above.

A query presents at block 217 to ask if an impact is involved in the skill or activity. If the answer is yes, the process 200 proceeds to block 218, and if the answer is no, the process proceeds to block 225.

At block 218, a query presents to ask if ground contact is involved in the skill or activity. If the answer is yes, the process 200 proceeds to block 219, and if the answer is no, the process 200 proceeds to block 225.

At block 219, previously collected contact information including data related to ground forces, moments and locations of force applications are retrieved from one or both of the computer 20 hard drive storage devices 16 or 18 where such data are stored during the data collection process described above. For instance, if the student struck the ground with his/her foot, the computer 20 would retrieve data related to the linear and angular forces and the contact point.

At block 220, a query presents to ask if the implement or equipment is attached to the student. If the answer is yes, the process 200 proceeds to block 221, and if the answer is no the process 200 proceeds to block 222.

At block 221, if the implement or equipment is attached to the student, previously collected angular and linear displacement and force data are retrieved from the computer 20 hard drive storage device 16 or 18 where such data are stored during the data collection process described above. Thus, if the student 8 used a golf club to strike the ball, the computer 20 would retrieve the linear and angular movement results of the club head.

At block 222, a query presents to ask if the implement or equipment is unattached to the student. If the answer to the query is yes, the process 200 proceeds to block 223 and block 224. If the answer is no, the process 200 proceeds to block 225.

At block 223, if the implement or equipment is unattached to the student, the process 200 attaches the linear displacement, velocity and acceleration data to each collected position of equipment segments.

At block 224, the computer 20 retrieves from the hard drive storage device 16 or 18, angular displacement, velocity and acceleration data stored on the hard drive storage device 16 or 18 during the data collection process described above. For instance, if a golf ball were impacted, the computer 20 would retrieve the linear and angular movement results of the ball's performance.

At block 225, a query presents to ask if the student performance (video record) is completed (finished). If the answer is yes, the process 200 proceeds to block 228. If the answer is no, the process 200 proceeds to block 226.

At block 226, if the performance (video record) is not completed, the video display is advanced to the next critical video position, and at block 227, the frame counter is incremented. The digitizing process is repeated beginning at block 214.

At block 228, if the performance (video record) is completed, the Performance Scoring Subroutine process 300 may be called to score the student's performance of the skill or activity throughout his/her entire performance of the skill or activity.

A query presents at block 229 to ask if performance errors are to be calculated. If the answer is yes, the process 200 proceeds to block 230, and if the answer is no, the process 200 proceeds to block 231.

At block 230, the Performance Errors Subroutine process 400 may be called and performance errors are calculated using scores derived used the Performance Scoring Subroutine process 300.

At block 231, a query presents to ask if an implement or equipment is involved in the skill or activity. If the answer is yes, the process 200 proceeds to block 232, and if the answer is no, the process 200 proceeds to block 234.

At block 232, a query asks if equipment fitting for the student is desired. If the answer is yes, the process 200 proceeds to block 233, and if the answer is no, the process 200 proceeds to block 234.

At block 233, the Equipment Fitting Subroutine process 500 may be called and completed.

At block 234, the student analysis data produced through the process 200 is stored in the computer for later use.

A query presents at block 235 to ask if equipment is involved in the skill or activity. If the answer is yes, the process 200 proceeds to block 236 at which the equipment analysis data produced through the process 200 is stored in the computer for later use, and the process 200 terminates.

If the answer is no to the query in block 235, the process 200 terminates.

Referring to FIG. 5, a flow diagram is provided that describes a process 300, referred to as the Performance Scoring Subroutine Program, of generating a comprehensive, qualitative based scoring analysis of a student's performance of a skill or activity, such as a golf swing. The process 300 comprises performing a statistical comparison between the performance data collected on a student performing a skill or activity and the corresponding results of the student's individual performance model. Specifically, the process 300 comprises an automated, statistically based scoring method that compares the performance results or values of a student performing a skill or activity with his/her individual performance model to thereby generate penalty scores based on such comparison. The penalty scores generated from the process 300 are quantitative measures that provide a reliable assessment of the student's performance with respect to his/her model's performance. The penalty scores may be used as an indication or evaluation tool to determine internally a level of the student's performance with respect to the student's individual performance model and how the subject is improving in his/her performance of the skill or activity. In addition, the penalty scores may be used as a measure or evaluation tool to assess externally the performances of the skill or activity between different students.

The Performance Scoring Subroutine process 300 described below is exemplary and not limiting. The process 300 can be altered, e.g., by having “blocks” added, removed or rearranged.

The process 300 begins at block 301 with a system computer 20 reading or loading a student's individual performance model of his/her ideal or superior performance of a skill or activity generated in accordance with the systems and methods disclosed in U.S. Pat. No. 4,891,748 and U.S. Pat. No. 5,184,295 and in accordance with the process 100 disclosed herein and referred to as the Segment Trend Subroutine.

At block 302, the computer 20 reads or loads statistical standard deviations that correspond to the individual performance model data. Such standard deviations are deviations from the means (averages) of all of the body movement results of the elite performers, which were used to generate the individual performance model. Such standard deviations serve as the means by which the student's actual performance will be judged. For instance, if the position of the student's hands is known when the ball is impacted during a golf swing, such position is compared to the known hand position of the student's individual performance model. The degree of deviation between the student's actual hand positions and the model's positions can be determined by comparing the difference to the standard deviation of this body movement result. If the difference in the actual and model hand positions is three inches and the standard deviation is one inch, then a major problem is indicated.

At block 303, a query presents to ask if equipment is involved in the individual performance model's performance of the skill or activity. If the answer to the query is yes, the process 300 proceeds to block 304. If the answer is no, the process proceeds to block 316.

At block 304, if an implement or equipment is involved in the student's performance, the computer 20 reads or loads equipment results generated from the student's individual performance model.

At block 305, the computer 20 reads or loads statistical standard deviations that correspond to the equipment data. Such standard deviations are deviations from the means (averages) of all of the equipment movement results of the elite performers, which were used to produce the individual performance model. Such standard deviations serve as the means by which the student's equipment performance will be judged. For instance, if the club head speed of the student's golf club during the student's actual performance of a golf swing is 15 mph slower than the student's individual performance model, and the standard deviation of this equipment movement result is 2 mph, a major weakness is indicated.

At block 306, a query presents to ask if impact is involved in the student's performance of the skill or activity. If the answer to the query is yes, the process 300 proceeds to block 307 and three additional sets of performance data may be imputed into the computer 20, including ground contact data, attached equipment data and unattached equipment data. If the answer is no, the process 300 proceeds to block 316.

At block 307, a query presents to ask if ground contact is involved in the student's performance of the skill or activity. If the answer is yes, the process 300 proceeds to block 308, and if the answer is no, the process 300 proceeds to block 310.

At block 308, if the student contacts the ground, either directly or through an implement or equipment during the student's performance, computer 20 loads equipment results of the student's individual performance model.

At block 309, the computer 20 reads or loads a known statistical standard deviation that corresponds to each of the student's individual performance model ground contact results (model or model plus equipment).

At block 310, a query presents to ask if the implement or equipment involved in performance of the skill or activity is attached to the student. If the answer to the query is yes, the process 300 proceeds to block 311. If the answer is no, the process 300 proceeds to block 313.

At block 311, the results of attached equipment impact generated from the student's individual performance model are read or loaded into the computer 20.

At block 312, the computer 20 reads or loads statistical standard deviations that correspond to attached equipment impact results for the student's model.

A query presents at block 313 to ask if unattached equipment is involved. If the answer to the query is yes, the process 300 proceeds to block 314. If the answer is no, the process 300 proceeds to 316.

At block 314, the computer 20 reads or loads results of unattached equipment impact generated from the student's individual performance model.

At block 315, the computer 20 reads or loads statistical standard deviations that correspond to unattached equipment impact results for the student's model.

At block 316, to begin the scoring process 300, a frame counter associated with the computer 20 is initialized or zeroed.

At block 317, a total performance score value is zeroed, and at block 318, a total equipment score value is zeroed in the computer 20.

At block 319, the computer 20 initiates the process 300 of scoring all of the student's body segment movements, e.g., from toe to fingers. The student movement data generated previously in the Quantitative Performer Evaluation Subroutine process 200 described above passes to this process 300. Using this movement data along with the corresponding movement data of the student's individual performance model and the performance model's standard deviation of this movement result, a statistical based score can be determined.

At block 320, a statistical z score of a movement result, which represents data indicating positions and linear and angular movement directions of one or more body segments throughout the performance of the skill or activity, is computer-derived by comparing the movement result of the individual performance model and the movement result of the student's actual performance using the equation:

$${SPS}_{T} = {\sum }_{i = 1}^{n} ( ( \vert {mrm}_{i} - {mrs}_{i} \vert ) / {sdm}_{i} )$$

where
SPS_{T}=Total Student Performance Score for the student's entire movement
i=movement result being scored
n=total number of movement results being evaluated
mrm=movement result of the student's model
mrs=movement result of the student
sdm=standard deviation of the movement result of the model

For instance, using the above equation, if the student's horizontal hand speed is 10 ft/sec. at ball impact in a golf swing, while the student's individual performance model demonstrates a hand speed at ball impact of 15 ft/sec. and the performance model's standard deviation for this velocity result is 2 ft/sec., then the Total Student Performance Score for the student's hand velocity at this point is 2.5 ((15−10)/2).

At block 321, the individual penalty or z score derived is added to any z score(s) previously derived for other body segments to produce a Total Student Performance Score (SPS_{T}).

At block 322, the process 300 returns to block 319 and 320 to repeat these processes for each body segment of the student during his/her performance of the skill or activity to be included in the Total Subject Performance Score (SPS_{T}). As noted above, the applicant has found that a minimum of twenty nine individual skeletal body segments involving toe, heel, ankle, knee, hip, iliac, shoulder, arm, elbow, wrist, hand, ears, nose and vertebral segments provide an accurate representation of a student's body, although the invention is not limited to such body segments and may include others to provide a representation of a student's body.

At block 323, after completion of scoring of movement results of all body segments, a query presents to ask if an implement or equipment is involved in the skill or activity. If the answer to the query is yes, the process 300 proceeds to block 324. If the answer is no, the process 300 proceeds to block 345.

At block 324, the computer 20 initiates the process 300 of scoring all of the student's equipment segment movements. The equipment movement data generated previously in the Quantitative Performer Evaluation process 200 described above passes to this process 300. Using this movement data along with the corresponding equipment movement data of the student's individual performance model and the performance model's standard deviation of this equipment movement result, a statistical based score can be determined.

At block 325, a statistical z score of the movement result is computer-derived by comparing the movement result of the implement or equipment used in the student's individual performance model and the movement result produced by the student's actual performance of the skill or activity using the equation:

$${EPS}_{T} = {\sum }_{i = 1}^{n} ( ( \vert {mrme}_{i} - {mrse}_{i} \vert ) / {sdme}_{i} )$$

where
EPS_{T}=Total Equipment Performance Score for the subject's entire movement
i=equipment movement result being scored
n=total number of equipment movement results being evaluated
mrme=movement result of the student's model equipment
mrse=movement result of the student's equipment
sdme=standard deviation of the movement result of the model

For instance, using the above equation, if the student's club head speed is 65 ft/sec. during the initial takeaway in a golf swing, while the student's individual performance model demonstrates 82 ft/sec. and the performance model's standard deviation for this velocity result is 5.4 ft/sec., then the Total Student Performance Score for the student's club head velocity at this point is 3.148 ((82−65)/5.4).

At block 326, the individual z or penalty score derived is added to any z score(s) previously derived for other segments of the implement or equipment to produce a Total Equipment Performance Score (EPS_{T}).

At block 327, the process 300 returns to block 324 and 325 to repeat these processes for each segment of the implement or equipment the student uses during his/her performance of the skill or activity to be included in the Total Equipment Performance Score (EPS_{T}).

A query presents at block 328 to ask if impact is involved in the student's performance of the skill or activity. If the answer to the query is yes, the process 300 proceeds to block 329 for additional scoring processes, and if the answer is no, the process 300 proceeds to block 345.

At block 329, a query presents to ask if ground contact occurs in the student's performance of the skill or activity. If the answer to the query is yes, the process 300 proceeds to block 330 for additional scoring processes, and if the answer is no, the process 300 proceeds to block 334.

At block 330, the computer 20 begins the process 300 of scoring all of the ground contact segments (student or equipment) during the student's performance of the skill or activity. For instance, the ground contact vertical force application of the right toe of the student during the golf swing may be scored.

At block 331, using the EPS_{T} equation of block 325, a statistical z score of each ground contact value is derived.

At block 332, the individual z score or penalty score derived in block 331 is added to the Total Equipment Performance Score (EPS_{T}).

At block 333, the process 300 returns to block 330, 331 and 332 to repeat these processes for each ground contact value collected from the student's performance of the skill or activity to include all involved ground contact values in the Total Equipment Performance Score (EPS_{T}).

At block 334, a query presents to ask if the implement or equipment is attached to the student during the performance of the skill or activity. If the answer is yes, the process 300 proceeds to block 335, and if the answer is no, the process 300 proceeds to block 339.

At block 335, the computer 20 begins the process of scoring all of the equipment that is attached to the student. For instance, scoring may be performed on non-ground contact movement results values for a segment of a golf club, such as a golf club head, which may include linear and angular position values and velocity values in three directions.

At block 336, using the EPS_{T} equation of block 325, a statistical z score of each movement results value of the attached implement or equipment or the involved segment of the attached implement or equipment is derived.

At block 337, the individual z score or penalty score derived in block 336 is added to the Total Equipment Performance Score (EPS_{T}).

At block 338, the process 300 returns to blocks 335, 336 and 337 to repeat these processes for each attached movement results value to include all involved attached equipment movement results values in the Total Equipment Performance Score (EPS_{T}).

At block 339, a query presents to ask if the implement or equipment is unattached to the student during the performance of the skill or activity. If the answer is yes, the process 300 proceeds to block 340, and if the answer is no, the process 300 proceeds to block 345.

At block 340, the computer 20 begins the process 300 of scoring all of the equipment that is not attached to the student. For instance, scoring may be performed on non-ground contact movement results values for a golf ball, which may include linear and angular position values and velocity values in three directions.

At block 341, using the EPS_{T} equation of block 325, a statistical z score of each linear movement results value relating to linear velocity results and/or forces is derived.

At block 342, using the EPS_{T} equation of block 325, a statistical z score of each angular movement results value relating to angular results and/or forces is derived.

At block 343, the individual z score or penalty score derived in block 341 and in block 342 is added to the Total Equipment Performance Score (EPS_{T}).

At block 344, the process 300 returns to blocks 340, 341, 342, and 343 to repeat these processes for each unattached movement results value to include all involved unattached equipment movement results values in the Total Equipment Penalty Performance Score (EPS_{T}).

A query presents at block 345 to ask if the student's performance of the skill or activity is complete. If the answer to the query is yes, the process 300 proceeds to block 348, and if the answer to the query is no, the process proceeds to block 346.

At block 346, if the student's performance has additional positions, the position frame counter is incremented, if necessary, to display the additional positions of the student's performance of the skill or activity.

At block 347, the process 300 may return to block 319 to repeat the processes of reading or loading and scoring additional student and equipment performance movement results.

At block 348, the computer 20 saves the student movement scores for later use.

At block 349, a query presents to ask if equipment is involved in the student's performance of the skill or activity. If the answer to the query is yes, at block 350 the computer 20 saves the equipment movement scores for later use.

If the answer to the query in block 349 is no, the process 300 proceeds to block 359.

At block 351, a query presents to ask if impact is involved in the student's performance of the skill or activity. If the answer to the query is no, the process 300 proceeds to block 359. If the answer to the query is yes, the process 300 proceeds to blocks 352 and 353 to save ground contact scores, and to blocks 354 and 355 to save movement results scores of attached equipment, and to blocks 356, 357 and 358 to save movement results scores of unattached equipment for use at a later time.

At block 359, a standardized final performance score of the student's performance of the skill or activity is derived using the following equation:
ASPS_{T}=(SPS_{T}/n)
where
ASPS_{T}=Average Total Subject Performance Score for the student's entire movement;
SPS_{T}=Total Subject Penalty Score for the subject's entire movement; and
n=total number of movement results being evaluated.

To convert the ASPS_{T} to a range of between zero (0) and one hundred (100), the Standard Normal Z Table is used to determine the area under the standard normal curve for the value between zero (0) and ASPS_{T} (A_{0-Z}). The standardized result is then determined using the equation:
SSPS_{T}=100(100*(A_{0-Z}*2))
where
SSPS_{T}=Standardized Total Subject Performance Score for the subject's entire movement; and
A_{0-Z}=Area under the standard normal curve for the value between 0 and ASPS_{T}.

At block 360, a query presents to ask if equipment is involved. If the answer is yes, the process 300 proceeds to block 361, and if the answer is no, the process 300 may return to block 301 to start the process 300 again.

At block 361, a standardized final performance score of the student's performance of the skill or activity is derived using the following equation:
AEPS_{T}=(EPS_{T}/n)
where
AEPS_{T}=Average Total Equipment Performance Score for the student's entire movement;
EPS_{T}=Total Equipment Penalty Score for the subject's entire movement; and
n=total number of movement results being evaluated.

To convert the AEPS_{T} to a range of between zero (0) and one hundred (100), the Standard Normal Z Table is used to determine the area under the standard normal curve for the value between zero (0) and AEPS_{T} (A_{0-Z}). The standardized result is then determined using the equation:
SEPS_{T}=100(100*(A_{0-Z}*2))
where
SEPS_{T}=Standardized Total Equipment Performance Score for the subject's entire movement; and
A_{0-Z}=Area under the standard normal curve for the value between 0 and ESPS_{T}.

The process 300 may return to block 301 to begin, or the process 300 may be terminated.

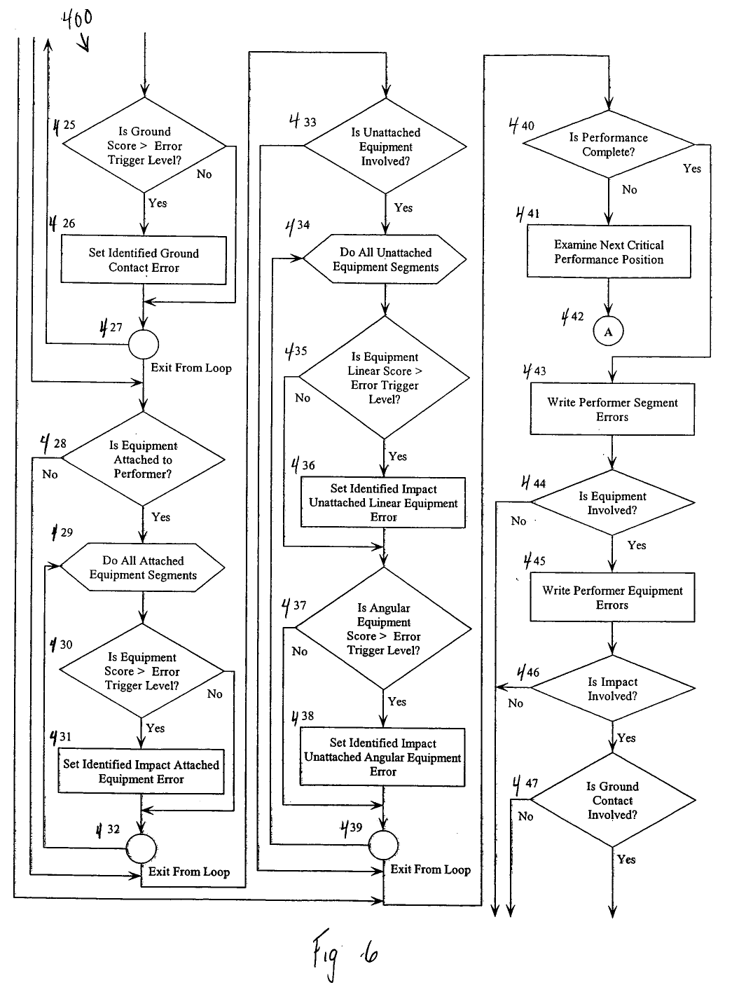

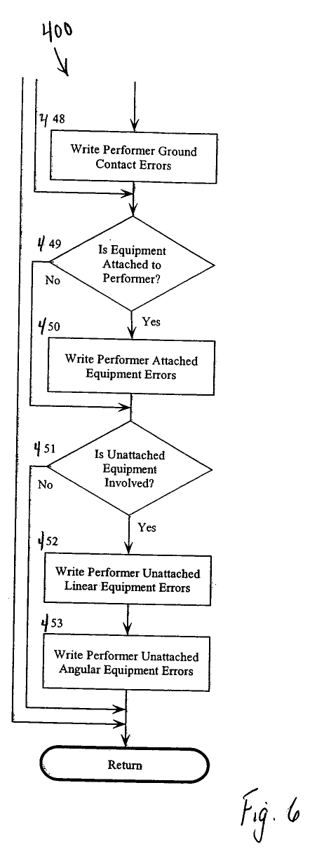

Referring to FIG. 6, a flow diagram is provided that describes a process 400, referred to as the Performance Errors Subroutine, of determining the movement errors of a student's performance of a skill or activity, such as a golf swing. The process 400 comprises comparing the penalty scores of a student's performance of a skill or activity generated by the Performance Scoring Subroutine process 300 described above with a selected range of tolerance or an error trigger level. If a student performance penalty score falls within a range of tolerance or meets or exceeds an error trigger level selected for the particular movement pattern or result, the movement pattern or result corresponding to the penalty score is flagged. More specifically, the process 400 comprises an automated, statistically based error identification system and method that compares the penalty scores corresponding to the student's performance results or values to an acceptable range of tolerance or error trigger level selected for a particular movement pattern or result, or a combination of movement patterns or results, to identify true movement errors that the student is producing. The process 400 thereby produces a comprehensive, qualitative based identification of movement errors based on a student's actual performance in contrast to less reliable, opinion based evaluations of performance that essentially only indicate whether errors are present or not.

In addition, the process 400 comprises comparing the performance penalty scores of an implement or equipment a student uses in his/her performance of a skill or activity. Each equipment penalty score generated by the Performance Scoring Subroutine process 300 described above is compared with a range of tolerance or an error trigger level selected for a particular equipment movement pattern or result. If an equipment penalty score falls within the range of tolerance or meet or exceeds the error trigger level, the equipment movement pattern or result corresponding to the penalty score is flagged. The process 400 similarly produces a comprehensive, qualitative based identification of movement errors due to the implement or piece of equipment a student uses during his/her performance of a skill or activity.

Using student performance penalty scores, the process 400 may help to identify those movements of a student's performance that need the most improvement by flagging large penalty scores. In addition, the process 400 may combine student performance penalty scores for individual body segment movement patterns or results that help to identify those individual portions of a movement pattern or result that need the most improvement. Further, individual student performance penalty scores may help to identify movement errors underlying or causing movement pattern or results errors.

The process 400 may further help to identify equipment movement patterns or results that need the most improvement by similarly flagging large penalty scores associated with equipment performance errors. In effect, larger penalty scores may help to identify those movement patterns or results in which equipment has a negative effect or no effect on a subject's performance, as well as to identify those movement patterns or results that need the most improvement. In addition, the process 400 may combine equipment penalty scores to flag individual portions of an equipment movement pattern or result that need the most improvement, and/or whether the type/kind of equipment has a positive, negative or no effect on the movement pattern(s) or results in question. The process 400 may use equipment penalty scores to help to identify equipment movement errors that are the underlying causes of other movement pattern or results errors caused by the type/kind of equipment a subject uses to perform a skill or activity.

As noted above, the process 400 compares student performance penalty scores and equipment performance penalty scores with selected ranges of tolerance and/or error trigger levels. For each performance error, the range of tolerance or error trigger level may be standardized for the particular performance error. For instance, some performance errors can have a narrow tolerance range or a low error trigger level where a student's (equipment's) performance deviates only slightly from the performance of his/her individual performance model, while other student (equipment) performance errors can have a wide range of tolerance or a high error trigger level where the student's (equipment's) performance deviates considerably from his/her model's performance. In addition, the tolerance ranges or error trigger levels may be used to assign different levels of severity for each student or equipment performance error.

For instance, with respect to a golf swing, if a subject's (performer's) right elbow motion during the downswing of a golf club produces a high performance penalty score, the process 400 may automatically flag the motion of the right elbow as a performance error for improvement. If the subject's entire right arm, including his/her wrist, elbow, and shoulder, produces a high penalty score, then the process 400 may flag automatically the subject's entire right arm during the downswing motion for improvement. In addition, if a student performance penalty score falls within a range of tolerance or exceeds an error trigger level to thereby identify poor movement of a student's right elbow during the downswing and the right elbow penalty score is significantly related to other student performance errors in the student's downswing, then the process 400 may flag automatically the downswing portion of the student's swing for improvement.

In another instance, with respect to a golf club's performance during a golf swing, if motion of the club head during a subject's downswing produces a high equipment penalty score, the process 400 may automatically flag the motion of the club head for improvement. If the entire club, including the club head and the shaft score high penalty scores, the process 400 may automatically flag the entire club for improvement. In addition, if poor movement patterns or results of the club head during the backswing are identified as equipment performance errors and such errors are significantly related to other equipment performance errors in the downswing, the process 400 may automatically flag that portion of the swing for improvement.

The Performance Errors Subroutine process 400 described above and below with reference to FIG. 6 is exemplary and not limiting. The process 400 can be altered, e.g., by having “blocks” added, removed or rearranged.

The process 400 starts at block 401 with selecting or setting an error trigger level (or range of tolerance) in the computer 20. In one embodiment, with the error trigger level set with a value of 1.0, the process 400 will identify performance errors if a student's performance penalty score(s) lie outside 68% of the performance results of elite performers, e.g., a predetermined number of PGA golf professionals, used to generate the individual performance model according to Programs A thru E and Programs Normalize-1 thru Normalize-3 disclosed in U.S. Pat. Nos. 4,891,748 and 5,184,295 and disclosed herein with respect to the Segment Trend Subroutine process 100. With the error trigger level set at a value of 2.0, the process 400 will identify performance errors if a student's performance penalty score(s) lie outside 95% of the performance results of elite performers. With the error trigger level set at a value of 3.0, the process 400 will identify performance errors if a student's performance penalty score(s) lie outside 99% of the performance results of elite performers.

At block 402, the computer 20 reads or loads a list of potential student performance errors that will vary with respect to the movement being analyzed. In golf, for instance, a list of potential performance errors may include, but is not limited to, such statements or descriptions that represent errors ranging from “Your right toe is too close to the ball at Setup” to “Your nose is too far from the target at the end of the swing”.

At block 403, a query presents to ask if an implement or equipment is involved in the student's performance of the skill or activity. If the answer the query is yes, the process 400 proceeds to block 404. If the answer is no, the process 400 proceeds to block 412.

At block 404, the computer 20 reads or loads a list of potential equipment (non-impact) performance errors that will vary due to the movement being analyzed. In golf, for example, this list may include statements or descriptions that represent errors ranging from “Your club is too far inside during the Takeaway” to “Your ball is too far back in your stance at Setup”.

At block 405, a query presents to ask if impact is involved in the student's performance of the skill or activity. If the answer is yes, the process 400 proceeds to block 406, and if the answer is no, the process 400 proceeds to block 412.

At block 406, a query presents to ask if ground contact occurs between the student and the ground during the student's performance of the skill or activity. If the answer is yes, the process 400 proceeds to block 407, and if the answer is no, the process 400 proceeds to block 408.

At block 407, the computer 20 reads or loads a list of potential ground impact performance errors that will vary with respect to the movement being analyzed. In golf, for instance, a list of potential performance errors may include such statements or descriptions that represent such errors ranging from “Your weight shift is too low on the left side during the Downswing” to “Your weight distribution is too much on the left side at Setup”.

At block 408, a query presents to ask if equipment is attached to the student during the student's performance. If the answer is yes, the process 400 proceeds to block 409, and if the answer is no, the process 400 proceeds to block 410.

At block 409, the computer 20 reads or loads a list of potential attached equipment (impact) performance errors that will vary with respect to the movement being analyzed. In golf, for example, this list may include statements or descriptions representing errors ranging from “Your club head is too open at Impact” to “Your club head velocity is too low at Impact”.

At block 410, a query presents to ask if equipment is unattached to the student during the student's performance. If the answer is yes, the process 400 proceeds to block 411, and if the answer is no, the process 400 proceeds to block 412.

At block 411, the computer 20 reads or a list of potential unattached equipment (impact) performance errors that will vary with respect to the movement being analyzed. In golf, for instance, a list of potential performance errors may include statements or descriptions that represent errors ranging from “Your ball velocity is too low” to “Your ball backspin is too high”.

At block 412, the computer 20 initializes or zeroes a frame counter associated with the computer 20.

At block 413, the process of determining all of the student's segment performance errors (from toe to fingers) is initiated. The student performance score data generated previously in the Performance Scoring process 300 is passed to this process 400. The process 400 uses the student performance score data to determine the student's statistical based performance errors.

At block 414, a query presents to ask if the performance penalty score(s) exceeds the selected error trigger level, e.g., 1.0, 2.0 or 3.0. If the answer is yes to the query, the process 400 proceeds to block 415, and if the answer is no the process 400 proceeds to block 416. Thus, in golf, if a right hand position score at the end of the Backswing in golf is 1.5, and the selected error trigger level is 1.0, then a performance error has occurred and is identified.

At block 415, the body segment, or the combination of body segments, to which the penalty score(s) correspond is (are) set as error(s). For instance, in golf, an error that corresponds to a right hand position score exceeding the trigger level in the positive direction may be identified with one or more statements or descriptions retrieved from the performance error list including, but not limited to, “Your right hand is too far inside at the end of the Backswing”. This error statement may be displayed on the teaching monitor 25 to identify the error.

At block 416, the process 400 may return to block 413 to repeat the processes of blocks 413, 414 and 415 through all involved body segments in order to set the body segments, or the combinations of body segments, that have corresponding penalty score(s) that exceed the selected error trigger level.

The process proceeds to block 417 upon completion of the process of block 415, and presents a query to ask if equipment is involved. If the answer is yes, the process 400 proceeds to block 418, and if the answer is no, the process 400 proceeds to block 428.

At block 418, the computer 20 initiates the process 400 of identifying all of the student's equipment (non-impact) performance errors. The student performance score data previously generated in the Performance Scoring process 300 passes to this process 400 and the student's statistical based performance errors are identified.

At block 419, a query presents to ask if the equipment penalty score(s) exceed the selected error trigger level, e.g., 1.0, 2.0 or 3.0. If the answer is yes to the query, the process 400 proceeds to block 420, and if the answer is no, the process 400 proceeds to block 421. For instance, in golf, if a lateral club head position score at the top of golf swing is −2.5, and the selected error trigger level is 2.0, then a performance error has occurred and is identified.

At block 420, the equipment segment, or the combination of equipment segments, to which the equipment penalty score(s) correspond is (are) set as error(s). For instance, in golf, an error that corresponds to a lateral club position score exceeding the selected trigger level in the negative direction may be identified with one or more statements or descriptions retrieved from the error list including, but not limited to “Your club head is too far across the line at the top of the swing”. This error statement may be displayed on the teaching monitor 25 during a teaching process.

At block 421, the process 400 may return to block 418 to repeat the processes of blocks 418, 419 and 420 through all involved equipment segments in order to set the equipment segments, or the combinations of equipment segments, that have corresponding penalty score(s) that exceed the selected error trigger level.

At block 422, a query presents to ask if impact is involved with the implement or equipment used in the student's performance. If the answer is yes, the process 400 proceeds to block 423. At block 423, a second query asks if ground contact is involved with the implement or equipment. If the answer to the query of block 423 is yes, the process 400 proceeds to block 424, and if the answer is no, the process 400 proceeds to block 428.

If the answer to the query of block 422 is no, the process 400 proceeds to block 440.

At block 224, the computer 20 initiates the process 400 of determining all of the student's ground contact performance errors. The student performance score data generated previously in the Performance Scoring process 300 is passed to this process 400 to determine the student's statistical based performance errors.

At block 425, a query presents to ask if the equipment penalty score(s) exceed the selected error trigger level, e.g., 1.0, 2.0 or 3.0. If the answer is yes to the query, the process 400 proceeds to block 426, and if the answer is no, the process 400 proceeds to block 427. For instance, in golf, if a vertical left toe force score at the top of the swing is 1.25, and the selected error trigger level is 1.0, then a performance error has occurred and is identified.

At block 426, the student segment or the equipment segment, or combinations of the student segments or the equipment segments, is (are) set as error(s). In golf, an error corresponding to, for instance, a vertical left toe force score exceeding the selected trigger level in the positive direction may be identified with one or more statements or descriptions retrieved from the error list, including, but not limited to, “Your weight is shifted too much on the left side at the top of the swing.” This error statement may be displayed on the teaching monitor 25 during a teaching process.

At block 427, the process 400 may return to block 424 to repeat the processes of blocks 424, 425 and 426 through all student or equipment segments involved in ground contact.

At block 428, a query presents to ask if the implement or equipment is attached to the student during his/her performance of the skill or activity. If the answer is yes, the process 400 proceeds to block 429, and if the answer is no the process proceeds to block 433.

At block 429, the process of determining all of the student's attached equipment (impact) performance errors is initiated. Using the student performance score data generated in the Performance Scoring process 300 and passed to this subroutine, the student's statistical based performance errors are to be determined.

At block 430, a query presents to ask if the equipment penalty score(s) exceed the selected error trigger level, e.g., 1.0, 2.0 or 3.0. If the answer is yes to the query, the process 400 proceeds to block 431, and if the answer is no the process 400 proceeds to block 432. Thus, if the horizontal club head velocity score at the Impact position of the swing in golf is 4.7, and the selected error trigger level is 2.0, then a performance error has occurred.

At block 431, the equipment segment, or the combination of equipment segments, attached to the student to which the equipment penalty score(s) correspond is (are) set. As in the above golf example, the error corresponding to the horizontal club head velocity score that exceeds the trigger level in the positive direction may be identified with one or more statements or descriptions retrieved from the error list including, but not limited to, “Your club head is too slow at Impact.” This error statement may be displayed on the teaching monitor 25 during a teaching process.

At block 432, the process 400 may return to block 420 to repeat the processes of blocks 429, 430 and 431 through all equipment segments involved that are attached to the student in order to set the equipment segments, or the combinations of equipment segments, attached to the student that have corresponding penalty score(s) that exceed the selected error trigger level.

At block 433, a query presents to ask if the implement or equipment is unattached to the student during his/her performance of the skill or activity. If the answer is yes, the process 400 proceeds to block 434, and if the answer is no the process proceeds to block 440.

At block 434, the computer 20 initiates the process 400 of determining all of the student's unattached equipment (impact) performance errors. The student performance score data generated previously in the Performance Scoring process 300 is passed to this process 400 to determine the student's statistical based performance errors.

At block 435, a query presents to ask if the equipment penalty score(s) that correspond to linear movement results of the unattached equipment segment, or combination of equipment segments, exceed the selected error trigger level, e.g., 1.0, 2.0 or 3.0. If the answer is yes to the query, the process 400 proceeds to block 436, and if the answer is no the process 400 proceeds to block 437. Thus, if the ball total velocity score at the post-Impact position of the swing in golf is −2.2, and the selected error trigger level is 2.0, then a performance error has occurred and is identified.

At block 436, the equipment segment, or the combination of equipment segments, unattached to the student to which the linear movement results penalty score(s) correspond is (are) set as error(s). As in the golf example above, an error corresponding to a ball velocity score that exceeds the trigger level in the negative direction may be identified with one or more statements or descriptions retrieved from the error list including, but not limited to, “Your ball velocity is too low after Impact.” This statement may be displayed on the teaching monitor 25 during a teaching process.

At block 437, a query presents to ask if the equipment penalty score(s) that correspond to angular movement results of the unattached equipment segment, or combination of equipment segments, exceed the selected error trigger level, e.g., 1.0, 2.0 or 3.0. If the answer is yes to the query, the process 400 proceeds to block 438, and if the answer is no the process 400 proceeds to block 439.

At block 439, the process 400 may return to block 434 to repeat the processes of blocks 435, 436, 437 and 438 through all equipment segments involved that are unattached to the student in order to set the equipment segments, or the combinations of equipment segments, unattached to the student that have corresponding penalty score(s) that exceed the selected error trigger level.

At block 440, a query presents to ask if the student performance is complete. If the answer is yes, the process 400 proceeds to block 443, and if the answer is no, the process 400 proceeds to block 441.

At block 441, if the answer to the query of block 440 is no indicating that additional critical positions of the student's or equipment's performance, and any corresponding performance penalty scores have not been considered, the process 400 increments the frame counter.

At block 442, the process 400 proceeds to block 413 to repeat the processes of blocks 413 and 440, if needed or desired.

At block 443, the set body segment errors are stored for later use.

At block 444, a query presents to ask if equipment is involved. If the answer is yes, the process 400 proceeds to block 445, and if the answer is no, the process 400 terminates or returns to start at block 401.

At block 445, the set equipment segment errors are stored for later use.

At block 446, a query presents to ask if impact is involved. If the answer is yes, the process 40 proceeds to block 447, and if the answer is no, the process 400 terminates or returns to start at block 401.

At block 447, a query presents to ask if equipment contacts the ground during the student's performance of the skill or activity. If the answer is yes, the process 400 proceeds to block 448 and if the answer is no, the process 400 proceeds to block 449.

At block 448, the set ground contact equipment errors are stored for later use.

At block 449, a query presents to ask if equipment is attached to the student during his/her performance. If the answer is yes, the process 400 proceeds to block 450, and if the answer is no, the process 400 proceeds to block 451.

At block 450, the set errors of equipment attached the student are stored for later use.

At block 451, a query presents to ask if equipment is unattached to the student during his/her performance. If the answer is yes, the process 400 proceeds to block 452, and if the answer is no, the process 400 terminates or returns to start at block 401.

At block 452, the set linear errors of equipment unattached to the student are stored for later use.

At block 453, the set angular errors of equipment unattached to the student are stored for later use, and the process 400 thereafter terminates or returns to start at block 401.

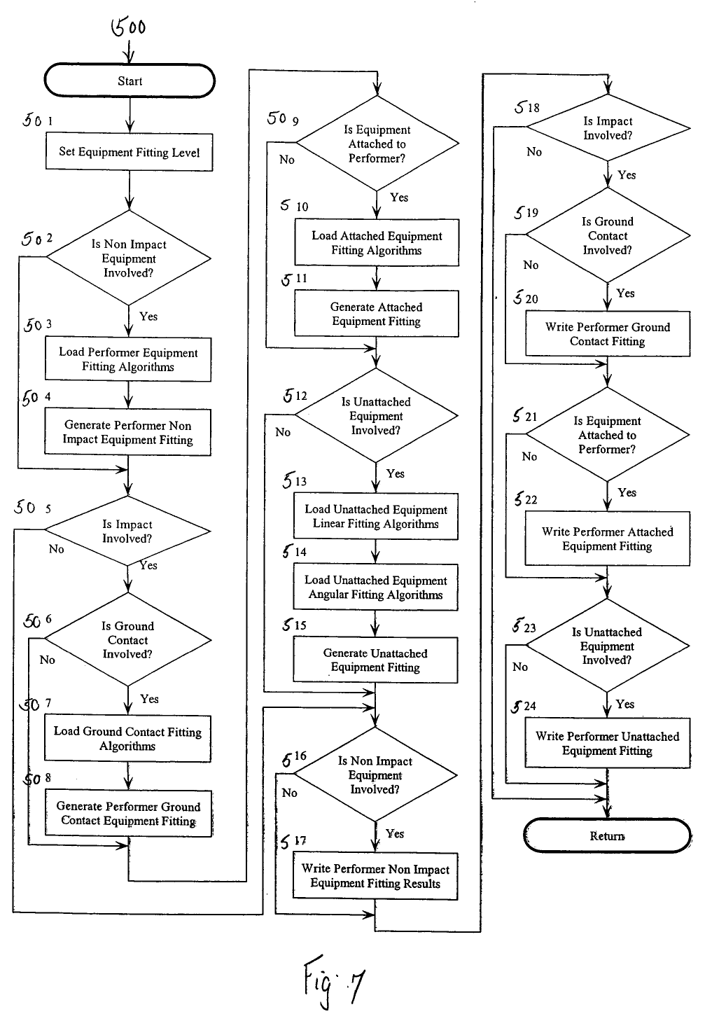

Referring to FIG. 7, a flow diagram is provided that describes a process 500 referred to as the Equipment Fitting Subroutine for fitting equipment to a particular student performing a particular skill or activity. The process 500 comprises using the penalty scores generated by the Performance Scoring Subroutine process 300 described above in equipment fitting algorithms designed specifically to determine the fitting parameters for each piece of equipment involved in the skill or activity to help to improve a student's performance. Using the penalty scores, the process 500 is a quantitative based method of fitting equipment that may be based on either a student's current performance of a skill or activity or the performance of the student's individualized superior performance model, generated according to Programs A thru E and Normalize-1 thru Normalize-3 disclosed in U.S. Pat. No. 4,891,748 and U.S. Pat. No. 5,184,295 and the Body Segment Trend Subroutine process 100 disclosed herein. Alternatively, the fitting process 500 may be based on a hypothetical performance of the student somewhere in between the two extremes of the student's current performance and the performance of his/her individual performance model.

A Fitting Variable Level is used in the process 500 that determines the basis of the fitting and corresponds to the desired level of performance of each student. A Fitting Variable Level representing either of the performance extremes, or representing the student's hypothetical performance somewhere in between the two performance extremes, controls the type of equipment fitting the process 500 produces. For instance, a Fitting Variable Level with a value of 0.0 is selected if an immediate improvement from the student's existing equipment is desired. In this case, the fitting process 500 helps to reduce performance errors identified by the Performance Scoring Subroutine process 300. If a Fitting Variable Level with a value of 1.0 is selected, the fitting process 500 produces an equipment fitting that helps to improve the student's performance using the student's individual performance model of his/her ideal or superior performance. A Fitting Variable Level having a value between 0.0 and 1.0 will produce a linear shift between these two fitting extremes.

A fitting variable level having a value greater than 0.0 is selected if it is desired that the student's equipment perform better as the student's performance improves. The closer the value of the fitting variable level gets to 1.0, the more the student must perform the skill or activity like his/her individual performance model to get the most out of his/her equipment. The result of the process 500 is a comprehensive, quantitative based equipment fitting that provides a more accurate fitting than opinion based fitting used in current analyses and teaching environments.

The process 500 described below with reference to FIG. 7 is exemplary and not limiting. The process 500 can be altered, e.g., by having “blocks” added, removed or rearranged.

The process 500 starts at block 501 with selecting and setting the value of the Fitting Variable Level.

At block 502, a query presents to ask if non-impact equipment is involved in a student's performance of a skill or activity. If the answer to the query is yes, the process 500 proceeds to block 503, and if the answer is no, the process proceeds to block 505.

At block 503, if equipment is not involved in an impact during the student's performance, the computer 20 reads or loads a non-impact equipment fitting algorithm including, for instance, the equation:

$${EFV}_{NT} = {EFV}_{NC} + FVL * ( {\sum }_{i = 1}^{n} ( {efc}_{i} * ( {EFM}_{NC} - {EFS}_{NC} ) ) )$$

where
EFV_{NT}=Equipment Fitting Value (non contact) after the fitting trend is applied;
EFV_{NC}=Current Student Fitting Value before the movement trend is applied;
FVL=Fitting Variable Level;
i=fitting component being processed;
n=number of fitting components;
efcᵢ=Equipment fitting constant;
EFM_{NC}=Current Student Fitting Result derived from student's model performance data; and
EFS_{NC}=Current Student Fitting Result derived from actual student performance data.

For instance, using the above equation, if the equipment fitting involves the golf club swing weight, which is an equipment fitting term, of the club of a golfer, the new swing weight (EFV_{NT}) would be determined by beginning with the current swing weight of the student's performance model (EFV_{NC}), then adding the swing weight alterations imposed by all of those non-contact fitting components that affect swing weight, such as, for instance, club head weight, club length, shaft flex and swing weight. This value is a product of the fitting constant related to the fitting component (efcᵢ) and the difference between the student's model performance value (EFM_{NC}) and the student's actual value (EFS_{NC}). The value is further adjusted by the amount that the fitting is to be shifted away from the student's model values (FVL).

The Fitting Results can be any component of the performance, from the components or combinations of linear or angular displacement, velocity, acceleration, or time. In addition, the trends may encompass any of the student body segments, or combinations thereof.

At block 504, the involved penalty scores of the student's performance that are produced with the Performance Scoring Subroutine process 300 are used in each equipment fitting algorithm. The algorithms are specifically designed to determine superior design demands and/or parameters of the involved equipment to thereby fit the equipment. For instance, the determination of the non-impact contribution to the Equipment Fitting Value of shaft flex of the student's golf club begins with the shaft flex of the student's performance model. This value is then altered by all of the fitting related components that affect shaft flex, e.g., swing, backswing, transition and downswing time, club velocity and acceleration throughout the swing, degree of weight shift, club angular position, velocity, and acceleration during the downswing, multiplied by the performance difference of these components between the student's performance and his/her individual performance model. Thus, desired shaft flex will decrease if the student under-performs with respect to their performance model in any of the listed components. For example, poor club shaft angle during the downswing may require a shaft flex reduction of 5 cpm to compensate. Finally, the actual total fitting adjustment is determined by the fitting variable. If this variable is set to 1.0, then the shaft flex fitting is adjusted to the current swing of the student. If it is set to 0.0, then none of the student's limitations are used, and the fitting result will be that of the student's performance model.

At block 505, a query presents to ask if an impact is involved with the equipment the student uses in his/her performance. If the answer is yes, the process 500 proceeds to block 506, and if the answer is no, the process 500 proceeds to block 516.

At block 506, a query presents to ask if ground impact is involved with the student body segments or the equipment segments. If the answer to the query is yes, the process 500 proceeds to block 507, and if the answer is no, the process 500 proceeds to block 509.

At block 507, the computer 20 reads or loads a ground contact equipment fitting algorithm including, for instance, the equation:

$${EFV}_{GT} = {EFV}_{GC} + FVL * ( {\sum }_{i = 1}^{n} ( {efc}_{i} * ( {EFM}_{GC} - {EFS}_{GC} ) ) )$$

where
EFV_{GT}=Equipment Fitting Value (ground contact) after the fitting trend is applied;
EFV_{GC}=Current Student Fitting Value before the movement trend is applied;
FVL=Fitting Variable Level;
i=fitting component being processed;
n=number of fitting components;
efcᵢ=Equipment fitting constant; and
EFM_{GC}=Current Student Fitting Result derived from student's model performance data.
EFS_{GC}=Current Student Fitting Result derived from actual student performance data.

For instance, using the above equation, if the equipment fitting involves the golf shoe support for the shoe of a golfer, the new support level (EFV_{GT}) would be determined by beginning with the current shoe support level of the student's performance model (EFV_{GC}), then adding the shoe support alterations imposed by all of those fitting components that affect support. This value is a product of the fitting constant related to fitting component (efcᵢ) and the difference between the student's model performance value (EFM_{GC}) and the student's actual value (EFS_{GC})). The value is further adjusted by the amount that the fitting is to be shifted away from the student's model values (FVL).

The Fitting Results can be any component of the performance, from the components or combinations of linear or angular displacement, velocity, acceleration, force, or time. In addition, the trends may encompass any of the student body segments, or combinations thereof.

At block 508, the involved penalty scores of the student's performance produced from the Performance Scoring Subroutine process 300 are used in each ground contact algorithm to determine superior design demands and/or parameters of the involved equipment to thereby fit the involved equipment to the student at the desired performance level. For instance, contact exists between the student and the ground throughout the student's golf swing; therefore, the ground contact algorithms may be used to determine the best fit of golf shoes for the student. If the value of the Fitting Variable Level is set near 0.0, the process 500 generates design demands and/or parameters of golf shoe that can handle the stress level and the timing currently produced by the student during his/her swing. If the value of the Fitting Variable Level shifts toward 1.0, the process 500 generates design demands and/or parameters of a golf shoe that can handle the stress level and the timing of the swing of the student's individualized performance model.

At block 509, a query presents to ask if the equipment is attached to the student. If the answer is yes, the process 500 proceeds to block 510, and if the answer is no, the process 500 proceeds to block 512.

At block 510, the computer 20 reads or loads an attached equipment fitting algorithm including, for instance, the equation:

$${EFV}_{AT} = {EFV}_{AC} + FVL * ( {\sum }_{i = 1}^{n} ( {efc}_{i} * ( {EFM}_{AC} - {EFS}_{AC} ) ) )$$

where
EFV_{AT}=Equipment Fitting Value (attached contact) after the fitting trend is applied;
EFV_{AC}=Current Student Fitting Value before the movement trend is applied;
FVL=Fitting Variable Level;
i=fitting component being processed;
n=number of fitting components;
efcᵢ=Equipment fitting constant;
EFM_{AC}=Current Student Fitting Result derived from student's model performance data; and
EFS_{AC}=Current Student Fitting Result derived from actual student performance data.

For instance, using the above equation, if the equipment fitting involves the effect of club-ball impact on the shaft flex of the golf shaft, the new shaft flex (EFV_{AT}) would be determined by beginning with the current shaft flex of the student's performance model (EFV_{AC}), then adding the shaft flex alterations imposed by all of those contact fitting components that affect support. This value is a product of the fitting constant related to fitting component (efcᵢ) and the difference between the student's model performance value (EFM_{AC}) and the student's actual value (EFS_{AC})). The value is further adjusted by the amount that the fitting is to be shifted away from the student's model values (FVL).

The Fitting Results can be any component of the performance, from the components or combinations of linear or angular displacement, velocity, acceleration, force, or time. In addition, the trends may encompass any of the student body segments, or combinations thereof.

At block 511, the involved penalty scores of the student's performance produced from the Performance Scoring Subroutine process 300 are used in each attached equipment algorithm to determine superior design demands and/or parameters of the involved equipment to thereby fit the involved equipment. For instance, a golf club is equipment attached to the student during his/her performance. If the value of the Fitting Variable Level is 0.0, the process 500 generates design demands and/or parameters of a golf club that help to reduce the swing errors that the student currently produces during his/her swing. If the value of the Fitting Variable Level shifts toward 1.0, the process 500 generates design demands and/or parameters of a golf club that would help to improve the strengths of the swing of the student's individualized performance model.

At block 512, a query presents to ask if the student is using unattached equipment. If the answer is yes, the process 500 proceeds to block 513, and if the answer is no, the process 500 proceeds to block 516.

At block 513, the computer 20 reads or loads an unattached equipment linear fitting algorithm, and at block 514, the computer 20 reads or loads an unattached equipment angular fitting algorithm, including, for instance, the equation:

$${EFV}_{UT} = {EFV}_{UC} + FVL * ( {\sum }_{i = 1}^{n} ( {efc}_{i} * ( {EFM}_{UC} - {EFS}_{UC} ) ) )$$

where
EFV_{UT}=Equipment Fitting Value (unattached contact) after the fitting trend is applied;
EFV_{UC}=Current Student Fitting Value before the movement trend is applied;
FVL=Fitting Variable Level;
i=fitting component being processed;
n=number of fitting components;
efcᵢ=Equipment fitting constant;
EFM_{UC}=Current Student Fitting Result derived from actual student performance data; and
EFS_{UC}=Current Student Fitting Result derived from actual student performance data.

For instance, using the above equation, if the equipment fitting involves the effect of ball-club impact on the backspin of the golf ball, the new ball spin (EFV_{UT}) would be determined by beginning with the current ball spin of the student's performance model (EFV_{UC}), then adding the ball spin alterations imposed by all of those contact fitting components that affect spin. This value is a product of the fitting constant related to fitting component (efcᵢ) and the difference between the student's model performance value (EFM_{UC}) and the student's actual value (EFS_{UC})). The value is further adjusted by the amount that the fitting is to be shifted away from the student's model values (FVL).

The Fitting Results can be any component of the performance, from the components or combinations of linear or angular displacement, velocity, acceleration, force, or time. In addition, the trends may encompass any of the student body segments, or combinations thereof.

At block 515, the involved penalty scores of the student's performance produced from the Performance Scoring Subroutine process 300 are used in each unattached equipment algorithm to determine superior design demands and/or parameters of the involved equipment to thereby fit the involved equipment. For instance, a golf ball is equipment unattached to the student during his/her performance. If the value of the Fitting Variable Level is 0.0, the process 500 generates design demands and/or parameters of a golf ball that help to reduce the swing errors that the student currently produces during his/her swing. If the value of the Fitting Variable Level shifts toward 1.0, the process 500 generates design demands and/or parameters of a golf club that would help to improve the strengths of the swing of the student's individualized performance model.

At block 516, a query presents to ask if non-impact equipment is involved. If the answer is yes, the process 500 proceeds to block 517, and if the answer is no, the process 500 proceeds to block 518.

At block 517, the computer 20 stores the non-impact equipment fitting results for later use.

At block 518, a query presents to ask if impact equipment is involved. If the answer is yes, the process 500 proceeds to block 519, and if the answer is no, the process 500 terminates or returns to start at block 501.

At block 519, a query presents to ask if ground contact is involved. If the answer is yes, the process 500 proceeds to block 220, and if the answer is no, the process 500 terminates or returns to start at block 501.

At block 520, the computer 20 stores the impact equipment fitting results for later use.

At block 521, a query presents to ask if attached equipment is involved. If the answer is yes, the process 500 proceeds to block 522, and if the answer is no, the process 500 proceeds to block 523.

At block 522, the computer 20 stores the attached equipment fitting results for later use.

At block 523, a query presents to ask if unattached equipment is involved. If the answer is yes, the process 500 proceeds to block 524, and if the answer is no, the process 500 terminates or returns to start at block 501.

At block 524, the computer 20 stores the unattached equipment fitting results for later use, and the process terminates or returns to start at block 501.

It will be apparent to those persons of ordinary skill in the art that while the preferred embodiment has been described herein as being implemented by software, the teachings of the present invention could equally be implemented by hardware (for example, one or more application specific integrated circuits) or indeed by a mix of hardware and software. As a result, the scope of the present invention should not be read as being limited solely to software.

Having thus described at least one illustrative embodiment of the invention, various alterations, modifications and improvements will readily occur to those skilled in the art. Such alterations, modifications and improvements are intended to be with the scope and spirit of the invention. Accordingly, the foregoing description is by way of example only and is not intended as limiting. The invention's limit is defined only with respect to the equivalents thereto.

1. A method of providing a quantitative analysis of a subject's performance in undertaking a physical skill or task, the method comprising:
(i) obtaining a set of body measurements representative of one or more physical characteristics of the subject's body;
(ii) modifying an elite performance data model representative of a body movement pattern associated with a superior performance of the skill or task in accordance with the set of the subject body measurements to provide a customized individual subject performance data model representative of the body movement pattern for an ideal performance of the skill or task by the subject;
(iii) capturing video data of the subject undertaking the physical skill or task;
(iv) determining from the captured video data a set of data representative of the subject's body movements while undertaking the skill or task;
(v) identifying positional differences between body movements represented by the body movement data set derived from the video data, and body movements represented by the individual subject performance data model; and
(vi) quantifying one or more of the identified positional differences to provide a quantitative analysis of the extent to which the body movement pattern of the subject while undertaking the skill or task differs from the body movement pattern represented by the individual subject performance data model,
wherein a quantitative analysis of the subject's performance in undertaking the skill or task is provided.

2. The method of claim 1, further comprising reporting quantified positional differences.

3. The method of claim 2, wherein reporting comprises generating a score for one of: (i) one or more of each of the identified positional differences, and (ii) a group of the identified positional differences, that is representative of the extent to which the movement pattern of the subject while undertaking the skill or task differs from that represented by the individual subject performance data model.

4. The method of claim 2, further comprising setting a level of significance for the positional differences and selecting only those identified positional differences which exceed the set level of significance for reporting.

5. The method of claim 3, further comprising setting a level of significance for the positional differences and reporting only those identified positional differences which exceed the set level of significance.

6. The method according to claim 3, wherein reporting comprises retrieving from a data store and for one of: (i) each of the identified positional differences, and (ii) the group of identified positional differences, one or more phrases that convey to the subject in the parlance of the skill or task being undertaken a reason for the difference between the subject's body movement pattern while undertaking the skill or task and that which is represented by the individual subject performance data model.

7. The method according to claim 4, wherein reporting comprises retrieving from a data store and for one of: (i) each of the identified positional differences, and (ii) the group of identified positional differences, one or more phrases that convey to the subject in the parlance of the skill or task being undertaken a reason for the difference between the subject's body movement pattern while undertaking the skill or task and that which is represented by the individual subject performance data model.

8. The method of claim 1, wherein the set of body measurements of the subject's body is derived from video images of the subject.

9. The method of claim 1, wherein the set of body measurements is derived from information provided by the subject.

10. The method of claim 1, further comprising determining from the set of body measurements of the subject's body significant body-segment measurements, and further modifying the individual subject performance data model to account for limitations imposed upon the subject's ideal performance of the skill or task by the significant body-segment measurements.

11. The method of claim 1, further comprising deriving from the video data captured while the subject undertakes the skill or task, an equipment data set representative of equipment movement as the subject performs the skill or task.

12. The method of claim 10, further comprising modifying an elite equipment data model representative of an equipment movement pattern associated with superior performance of the skill or task in accordance with the set of body measurements of the subject's body to provide a customized individual subject equipment performance data model representative of an equipment movement pattern for an ideal performance of the skill or task by the subject

13. The method of claim 10, further comprising comparing the equipment data set derived from the video data captured while the subject performs the skill or task with the individual subject equipment performance data model; and identifying positional differences between equipment movements represented by the equipment movement data set derived from the video data, and equipment movements represented by the individual subject equipment performance data model.

14. The method of claim 12, further comprising quantifying any identified positional differences to provide a quantitative analysis of the extent to which the movement pattern of the subject's equipment while undertaking the skill or task differs from the individual subject equipment movement pattern represented by the individual subject equipment performance data model.

15. The method of claim 13, further comprising generating a score for one of: (i) one or more of each of the identified differences, and (ii) a group of identified differences, that is representative of the extent to which the movement pattern of the subject's equipment while undertaking the skill or task differs from that represented by the individual subject equipment performance data model.

16. The method of claim 12, further comprising determining from the set of body measurements of the subject significant body-segment measurements, and further modifying the individual subject equipment performance data model to account for limitations imposed upon the equipment's ideal performance by the subject's significant body-segment measurements.

17. The method of claim 15, further comprising determining a set of equipment fitting parameters from one of: (i) one or more of the identified and quantified differences, and (ii) from the modified individual subject equipment performance data model.

18. A computer program comprising one or more software programs products operable, when executed in an execution environment, configured to implement at least (ii), (iii) and (iv) of the method of claim 1.

19. A method according to claim 14, comprising comparing said set of equipment fitting parameters with a set of stored equipment parameters to identify one or more items of equipment each of which has physical characteristics falling within or within a predetermined acceptable range of said fitting parameters.

20. A system for providing a quantitative analysis of a subject's performance in undertaking a physical skill or task, the system comprising:
one or more video capture devices for capturing video data of the subject undertaking the physical task; and
a computer system comprising a processor, and one or more computer program products executable by the processor to:
(i) modify an elite data model representative of a body movement pattern associated with a superior performance of the skill or task in accordance with a set of body measurements representative of one or more physical characteristics of the subject's body to thereby provide a customized individual subject performance data model representative of a body movement pattern for an ideal performance of the skill or task by the subject;
(ii) capture video data of the subject undertaking the physical skill or task;
(iii) determine from the captured video data a set of data representative of body movements of the subject while undertaking the skill or task;
(iv) identify positional differences between body movements represented by the set of subject body movement data derived from the video data, and body movements represented by the individual subject performance data model; and
(v) quantify any identified positional differences to provide a quantitative analysis of the extent to which the movement pattern of the subject while undertaking the skill or task differs from the movement pattern represented by the individual subject performance data model,
wherein a quantitative analysis of the subject's performance in accomplishing the skill or task is provided.

21. A computer program comprising one or more software elements operable, when executed in an execution environment, to:
(i) modify an elite data model representative of a body movement pattern associated with a superior performance of a physical skill or task in accordance with subject body measurements representative of physical characteristics of a subject's body, and thereby provide a customized individual subject performance data model representative of a body movement pattern for an ideal performance of the skill or task by the subject;
(ii) capture video data of the subject undertaking the physical skill or task;
(iii) determine from the captured video data a set of data representative of subject body movements while undertaking the skill or task;
(iv) identify positional differences between body movements represented by the set of body movement data derived from the video data, and body movements represented by the individual subject performance data model; and
(v) quantify any identified positional differences to provide a quantitative analysis of the extent to which the movement pattern of the subject while undertaking the skill or task differs from the movement pattern represented by the individual subject performance data model,
wherein a quantitative analysis of the subject's performance in accomplishing the skill or task is provided.
